(19) United States
(12) Patent Application Publication
(10) Pub. No.: US 2014/0025591 A1
(43) Pub. Date: Jan. 23, 2014

(54) SYSTEM AND METHOD FOR RECORDING AND DELIVERING A PERSONAL LEGACY TO A BENEFICIARY

(71) Applicant: Digital Life Legacy, LLC, Frankfort, IL (US)

(72) Inventor: Anthony Villa, III, Frankfort, IL (US)

(21) Appl. No.: 13/942,138

(22) Filed: Jul. 15, 2013

Related U.S. Application Data
(60) Provisional application No. 61/671,465, filed on Jul. 13, 2012.
(60) Provisional application No. 61/798,589, filed on Mar. 15, 2013.

(51) Int. Cl. G06Q 50/18; G06Q 10/10

(52) U.S. Cl. CPC G06Q 50/186; G06Q 10/10
USPC 705/312

(57) ABSTRACT

A network-based system and a method for recording digital assets belonging to a first entity and delivering at least some of those digital assets to at least a second entity at a designated time or event is set forth. The system includes a designated server coupled to a network and including memory for storing digital assets, an electronic device, such as a computer or smart phone, configured to access the server via the network and capable of storing digital assets, and administrative tools for acquiring, storing, uploading, assigning and delivering digital assets to at least one person upon one of either a specified time or a specified event. Similarly, the method is focused on electronically delivering each assigned asset to the assigned entity upon occurrence of the specified time or event.

### TECHNICAL FIELD OF THE INVENTION

The present system and methods relate to a web-based personal archive. Specifically, the system and methods relate to an archive for an individual to record information, store documents, and create stories, all while living so that the information, documents and stories may be distributed to and shared with love-ones at a desired time, including after the individual's death.

### BACKGROUND OF THE INVENTION

Many people have the idea of keeping a journal to capture all the funny, sad, exciting and even occasionally mundane occurrences of a lifetime. They think that one day they can share that journal and all its stories with friends, family and sometimes others. Overwhelmed by the thought of sitting down to “put pen to paper”, few people ever follow through on such a plan. Likewise, some people regularly capture photos of events and believe that one day they can sit with others to leaf through an organized album of pictures. Again, the initial step of getting started often deters many from moving forward. Over time, the memories and stories fade, never to be shared, and the pictures get lost in a box, never to be enjoyed. Hope and good intentions are replaced by disappointment and regret. Ultimately, time runs out on everyone. Sadly, the departed no longer has a voice in the storytelling. And even more unfortunate, often times the departed had so much more to say. The present system and method (currently embodied to some extent at http://lib.azurewebsites.net/ gives users the opportunity to write the stories, share the pictures and capture the moments as they happen. It also gives the user a ‘voice’ after they have passed away.

Social media websites continue to grow in popularity because they enable an individual to easily capture life's moments as they happen. Moreover, sites like FACEBOOK®, TWITTER™ and INSTAGRAM™ enable users, regardless of technical abilities, to easily share their experiences with friends and loved ones. These sites have helped to create the newest luxury consumer good, one's own life story. Whether it's a tweet announcing your oldest child has graduated from high school or a status update that includes a photo of you crossing the finish line of your first marathon, you're likely to find it posted on a social medial website on any given day. The collection of these life experiences, and life stories, can serve as one's digital life legacy and when properly organized, they can be transformed into a personalized, luxury good. However, most people are prevented from transforming their digital assets into a personalized luxury good due to inherent limitations in existing social media websites.

The first challenge in converting digital assets into a luxury good using existing social media websites is an issue of location. As mentioned earlier, there are numerous social media websites, with each offering varying degrees of privacy and functionality. Invariably this leads to many of us having multiple accounts and subsequently placing valuable keepsakes in multiple locations. For example, a person may be re-tweeted by a favorite celebrity and want to catalog that as a life event. Meanwhile, that person may have used FACEBOOK® to capture and share all of the photos from his son's recent 8^{th} grade graduation ceremony. Both could be viewed as compelling events in his life story and therefore need to be a part of his digital life legacy. Furthermore, a person may have a text and voicemail from her daughter on her phone that isn't on any of her social media websites, yet is just as valuable to her and could help her document and tell her life story. All of these are examples of digital assets that, if combined, could be reproduced into a meaningful, and tangible, luxury good. Unfortunately, most people don't have the disposable income necessary to hire a personal historian or biographer to track down all of these digital keepsakes. So that leaves the user with the prospect of having to copy and paste all of these digital keepsakes into one location and subsequently discourages many of us from ever beginning the journey of documenting our life story, let alone converting it into a luxury good.

Second, while the ability to archive one's social media assets, or any digital assets, is available today and would provide a user with a common location to access the materials, the user is still faced with the daunting challenge of mining all of their materials to compile their meaningful events. Today there's not an easy way to catalog what is meaningful versus what is mundane at the time the content is added to the social media website. Some existing sites have attempted to add this type of catalog feature but the user is limited to their own experiences and can't catalog compelling life events that might be shared by the user and the user's friends or family. For example, if a person wanted to document the life events shared with his wife, he would have to mine my various social media websites to find photos or updates related to the both of us and then move those photos to a separate site that provided me with the tools necessary to arrange those digital keepsakes in a meaningful format. And again, I would have to do this for all of my social media websites in order to capture more of the shared life events with my wife. Thus, the time required to do this prevents many from even getting started.

Even if social media websites offered tools to easily aggregate, catalog, publish and selectively share our life's stories with friends and family, the next challenge is one of timing and delivery. For most of us, we're busy living our lives and it isn't until we look back over several years that we see the value in our experiences. It's at this point that our cumulative experiences—experiences that include milestone events in one's life, unique experiences over the course of a life lived and ultimately life lessons learned—can be molded into the luxury good described earlier.

During these moments of self-reflection, we often start to see the value in sharing some of our life stories with friends and family. However, the timing may not be right to share some of these stories or life lessons learned. For example, a husband goes through the exercise of capturing all of his life's events with his wife and, in a moment of self-reflection about his wife, decides that he has valuable advice on how to stay happily married. While it may be great advice, it likely would not make sense to share with his children who at the time were all under the age of twelve. Furthermore, this advice is very private in nature and he probably only wants his children to see it. Today, social media websites provide the ability to share information publicly or privately, but a user is not able to choose when he or she may want to share the information. Once again, the user is required to go to yet another third party utility or website to handle the secure delivery of a future message.

The ability to schedule a message to be delivered at some point in the future, and insure the delivery of that message, is well beyond the scope of most social media websites. The ability to schedule future messages assigned to specific friends and family members operates in a fashion that is similar to a will or trust. The difference is that unlike a will or trust, our messages are delivered electronically and do not have to become part of the legally binding will or trust. This service is a key differentiator. The present invention is not only capable of scheduling messages to be delivered at the appropriate time, but it is also capable of providing a valuable service to the user: peace of mind. That peace of mind comes in knowing that if for some unforeseen reason they were to suddenly pass away, their messages and keepsakes can automatically be delivered to their intended target.

There are plenty of social networking sites and systems available to bring individuals together in life. There are also ways for people to use cameras, voice-recorders, wills and trusts and other operations to leave behind information for loved ones. However, there is a significant time and expense requirement with many of these methods, and storage of photos, videos and legal documents can be burdensome. Further, none of these methods and systems are specifically designed to capture moments, such as events, thoughts, beliefs, images, and other personal information of a person's life, and then systematically deliver those moments to special loved ones at the appropriate time.

Until the invention of the present application, these and other problems in the prior art went either unnoticed or unsolved by those skilled in the art. The present invention provides solutions that will facilitate recording, storing and delivering such moments without requiring the expense of significant time or money on the part of the user.

### SUMMARY OF THE INVENTION

The present disclosure describes both a network-based system and a method for recording digital assets belonging to a first entity and delivering at least some of those digital assets to at least a second entity at a designated time or event. While specific embodiments of the system and method are disclosed, certain features and functionalities may be added to or removed from such embodiments to create other useful embodiments. Even though such embodiments may not be specifically set forth in the present disclosure, they are intended to be covered by the appended claims.

Generally speaking, the system comprises a designated server coupled to a network and including memory for storing digital assets, an electronic device, such as a computer or smart phone, configured to access the server via the network and capable of storing digital assets, a first administrative tool for acquiring digital assets belonging to the first entity and storing the digital assets on the electronic device, a second administrative tool for uploading the digital assets from the electronic device to the designated server, a third administrative tool for assigning at least some of the digital assets uploaded to the server to at least one second entity upon one of either a specified time or a specified event, and a fourth administrative tool for delivering the assigned digital assets to the at least one second entity on the occurrence of the specified time or specified event. It is possible that a single administrative tool may serve the multiple functionalities of the system.

In an embodiment of the system, at least one of the first, second, third and fourth administrative tools reside on the electronic device. In fact, each of the first, second, third and fourth administrative tools may reside on the electronic device.

Additional administrative tools may be included to organize the digital assets, personalize the digital assets, upload and hold the digital assets or otherwise manipulate the assets before delivery. The digital assets are at least one type selected from the group consisting of photos, videos, documents, audio files, cards, and messages.

As to the method, generally speaking, it comprises the steps of acquiring at least one digital asset and loading the asset onto an electronic device, uploading the at least one digital asset from the electronic device onto a server for storage, accessing the server via an electronic device, assigning the at least one digital asset uploaded to the server to an entity, designating one of either a time or an event for electronic delivery of each assigned asset, and upon occurrence of either the designated time or event, electronically delivering each assigned asset to the assigned entity.

In an embodiment of the method, the delivery of the assigned asset can be recurring, based on one of either a recurring event or recurring time, or singular, such as upon notice of the death of the system user.

These and other aspects and embodiments of the system and method will be more readily understood from a reading of the following disclosure in conjunction with the referenced appended drawing figures.

### BRIEF DESCRIPTION OF THE DRAWINGS

For the purpose of facilitating an understanding of the subject matter sought to be protected, there are illustrated in the accompanying drawings and appendices, embodiments thereof, from an inspection of which, when considered in connection with the following description, the subject matter sought to be protected, its construction and operation, and many of its advantages should be readily understood and appreciated.

A portion of the disclosure of this patent document, including the numerous appended figures, contains material which is subject to copyright and/or mask work protection. The owner has no objection to the facsimile reproduction by anyone of the patent document or the patent disclosure, as it appears in the Patent & Trademark Office patent file or records, but otherwise reserves all rights whatsoever.

FIGS. 1A-1D are representative screen shots of exemplary website pages describing the four key features of the disclosed system;

FIG. 2 is a screen shot of an exemplary login page for the disclosed system;

FIGS. 3A-3B are representative screen shots of additional login pages for the disclosed system;

FIG. 4 is a screen shot of an exemplary web page for adding “family members” in accordance with the disclosed system;

FIGS. 5A-5C are representative screen shots of additional web pages for adding and confirming information about “family members” in accordance with the disclosed system;

FIGS. 6A-6C are representative screen shots of exemplary web pages describing aspects of the disclosed system;

FIG. 7 is a screen shot of an exemplary FAQ web page for the disclosed system;

FIG. 8 is a screen shot of an exemplary login page for the disclosed system;

FIGS. 9-12 are representative screen shots of exemplary web pages for adding “artifacts” to leave behind in accordance with the disclosed system;

FIGS. 13 and 14 are representative screen shots of an exemplary invitation feature of the disclosed system;

FIGS. 15-19 are representative screen shots of an exemplary feature for adding keepsakes in the disclosed system;

FIGS. 20-28 are representative screen shots of exemplary website pages illustrating an assignment of keepsakes feature of the disclosed system and methods.

Some of the above referenced web pages may be viewable at the following website: http://lib.azurewebsites.net/.

FIG. 29 is an exemplary screen shot of a login screen of the disclosed system as an app for a smart phone (or other mobile electronic device);

FIGS. 30-46 are exemplary screen shots illustrating tools, benefits and features of a smart phone (or other mobile electronic device) app for the systems and methods of the present invention; and

FIGS. 47-53 are exemplary website pages illustrating a storybook feature of a specific embodiment of the present system and methods. Some of these pages may be viewable at the following website: http://lib.azurewebsites.net/.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

The system and methods are described and shown herein as embodied in both a web-based program, accessible from most any computer, and a smart phone app, accessible from most any smart phone or similar electronic device (e.g., Apple iPad, Tablets, etc.). While the following description and appended drawings are directed to a specific website and app design, it should be understood that the inventive functionality and operation of the disclosed system and methods are in no way limited to such illustrated embodiments.

Further, while Applicants have used specific terms to reference features of the system, e.g., LIB Biographer, LIB Keepsake, LIB Publisher, etc., such terms are merely exemplary and such described features should not be considered limited to the use of such terms, or even similar terms.

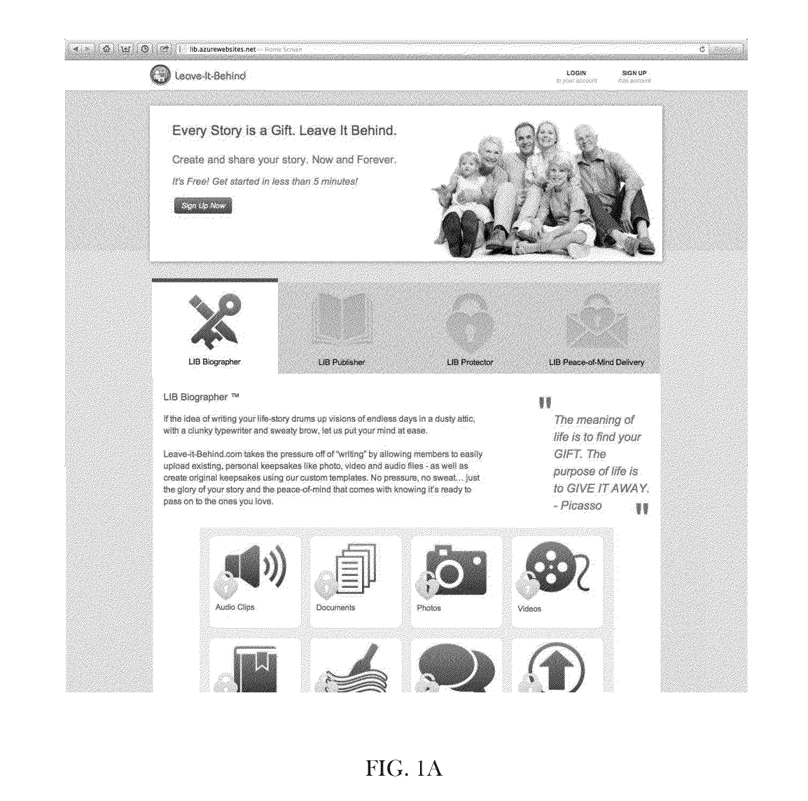

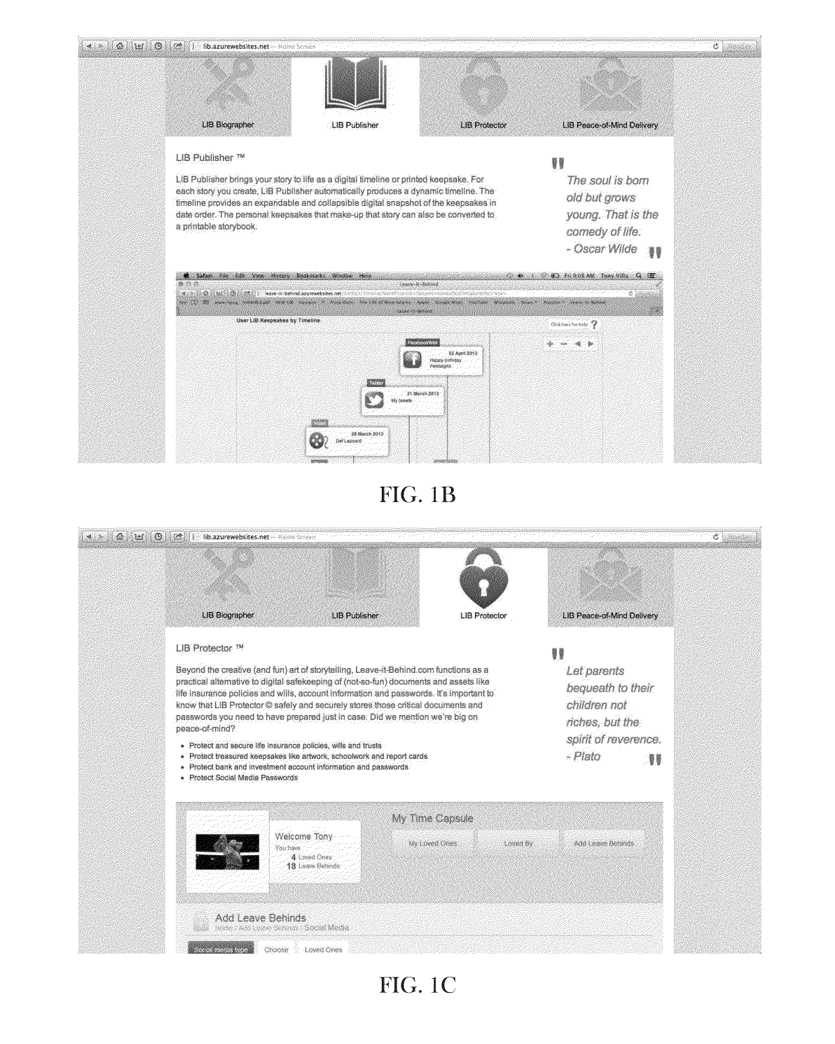

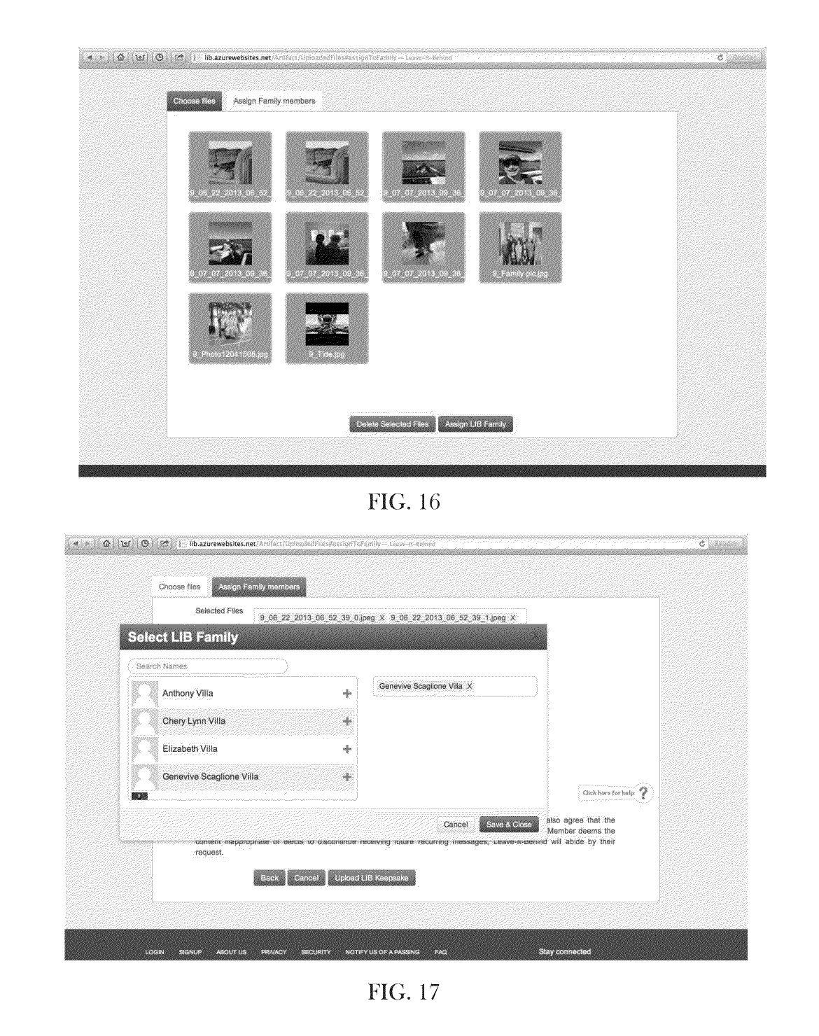

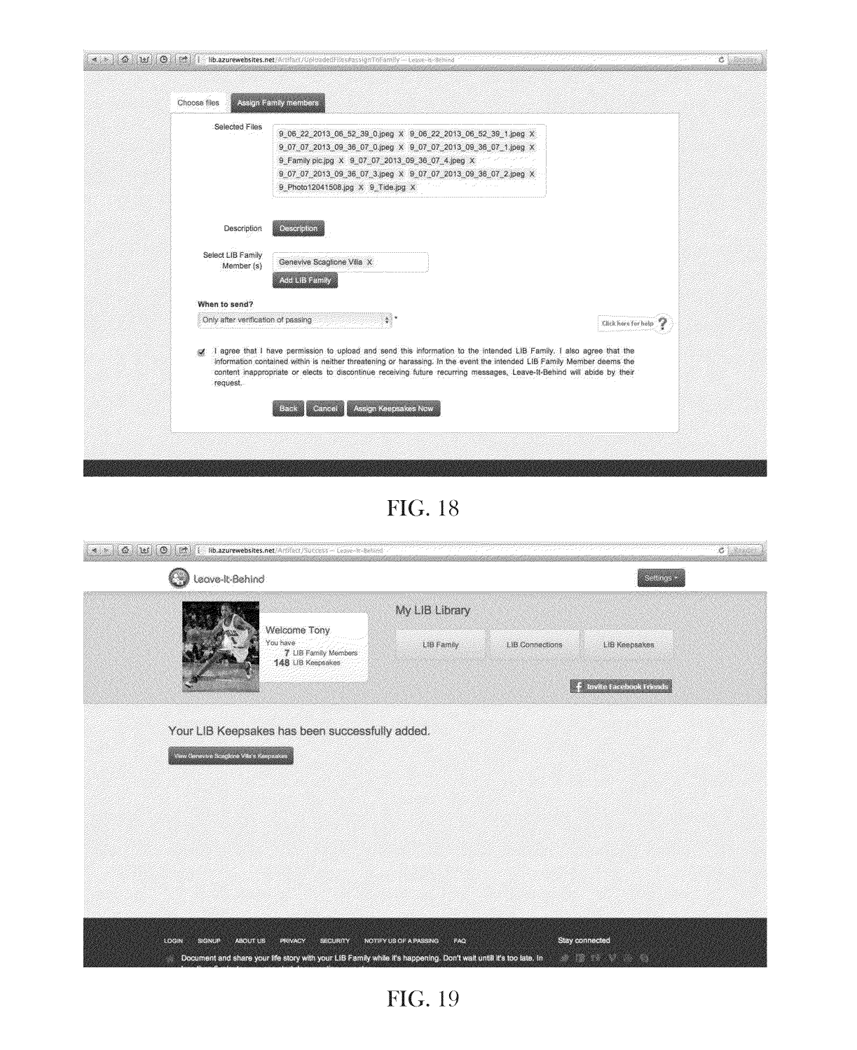

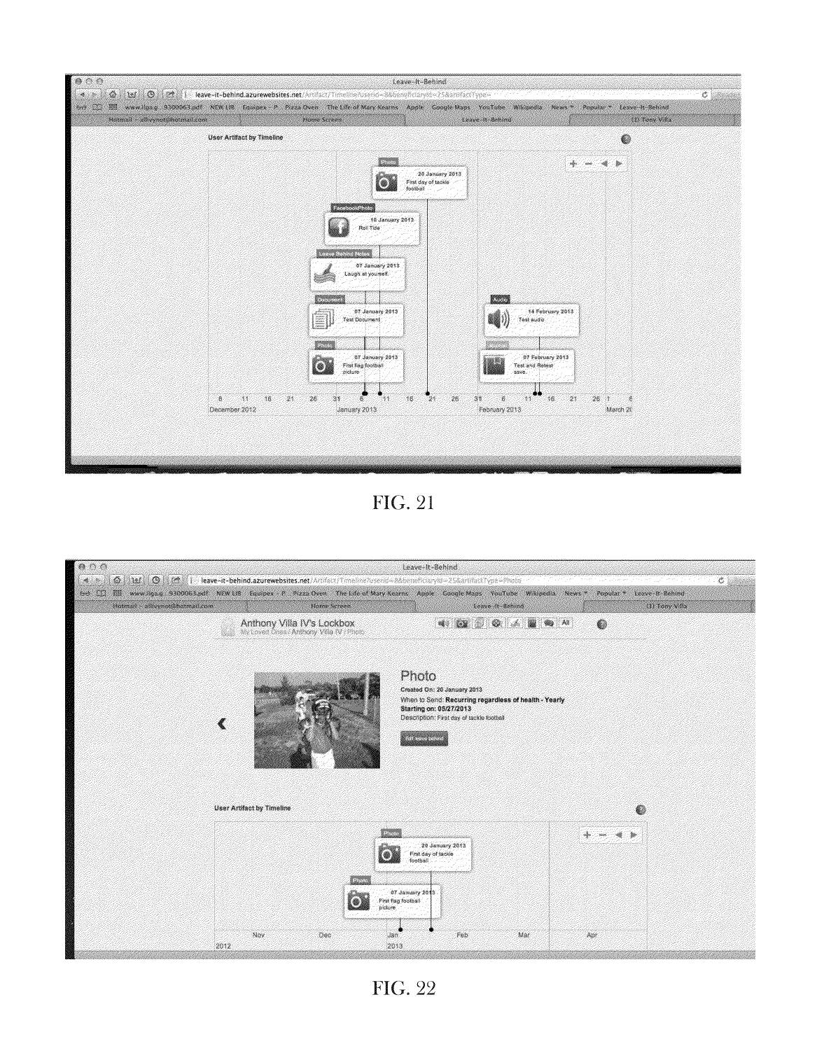

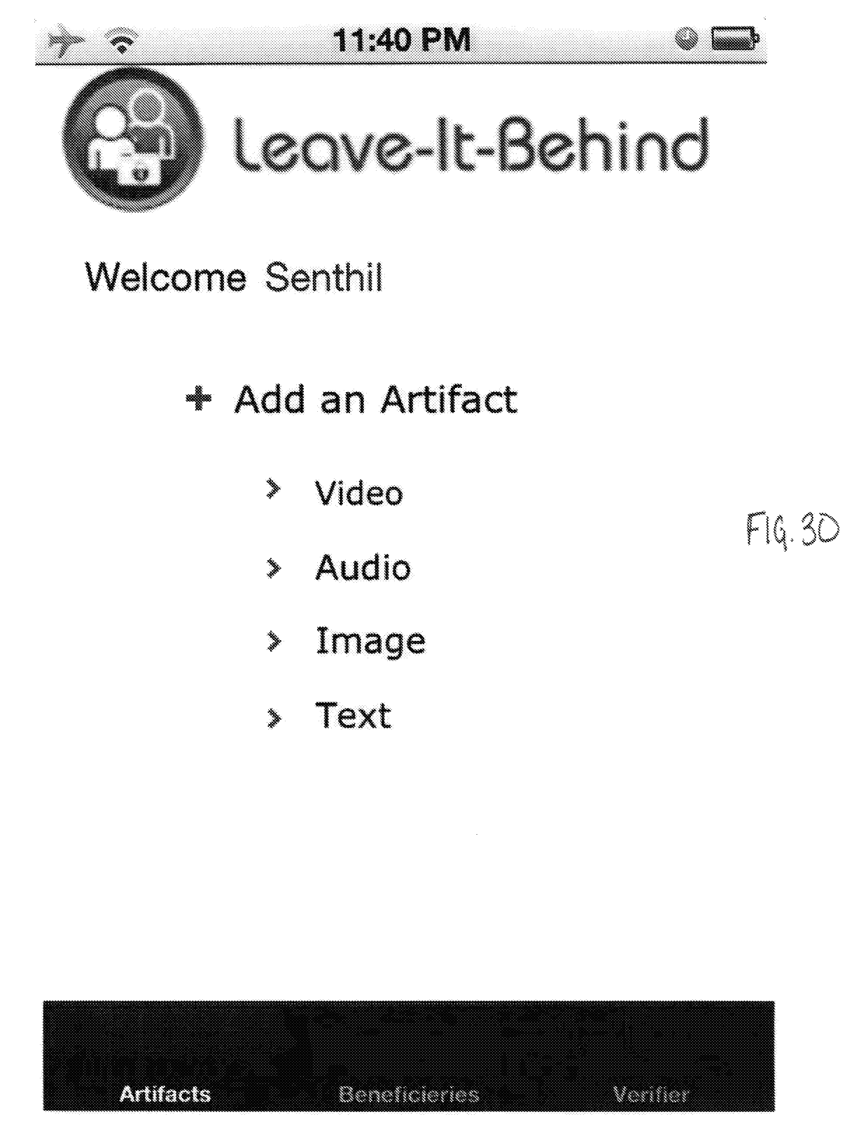

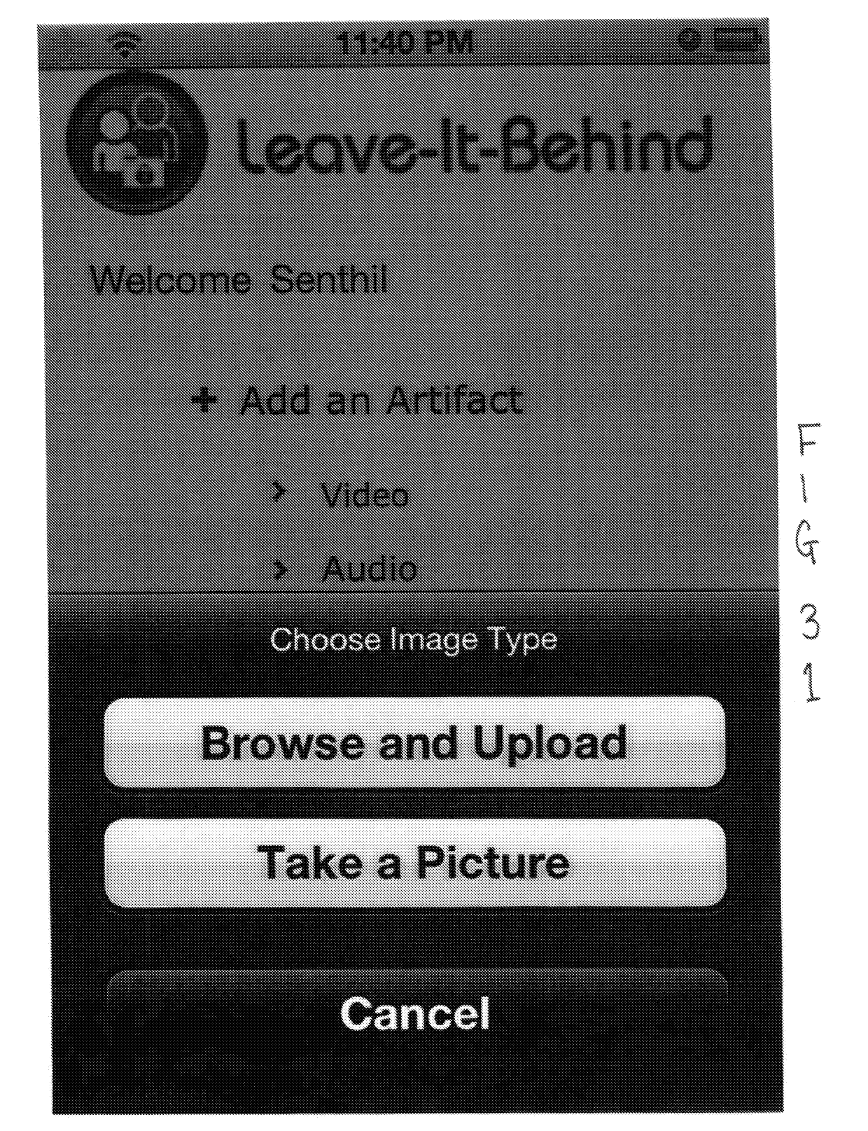

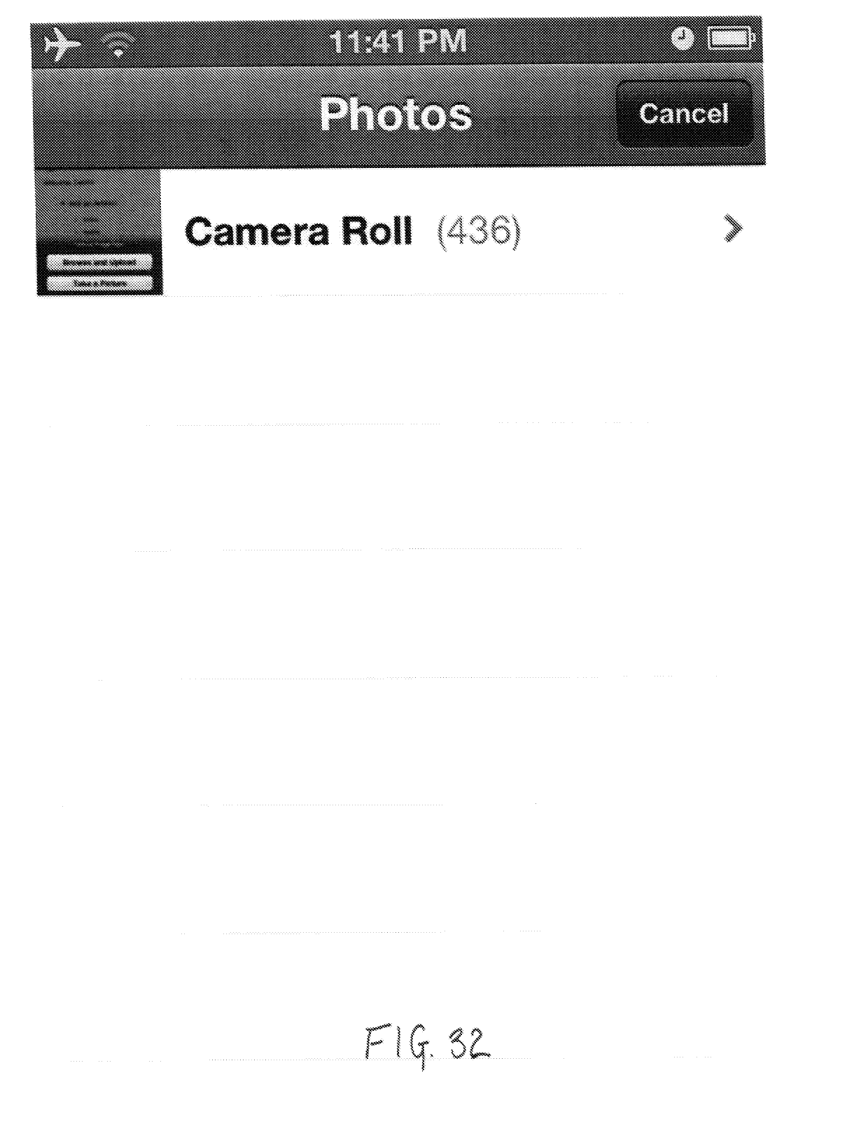

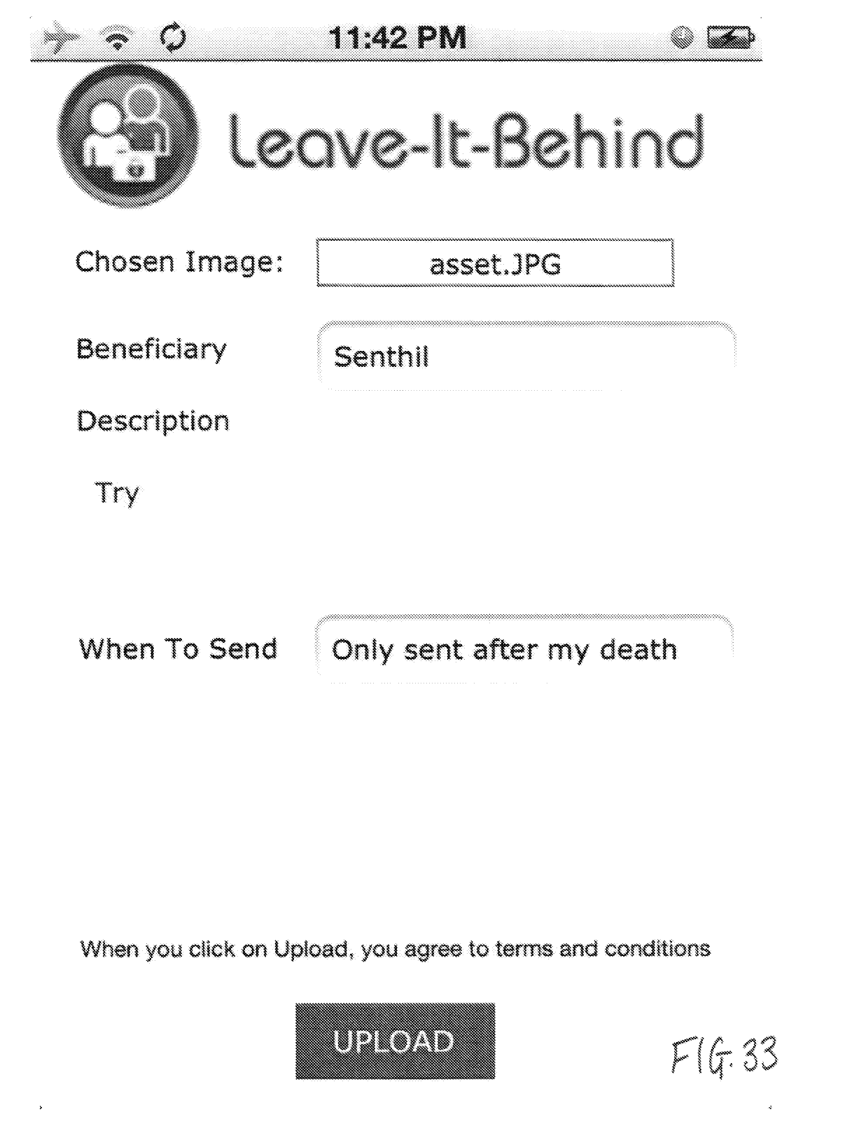

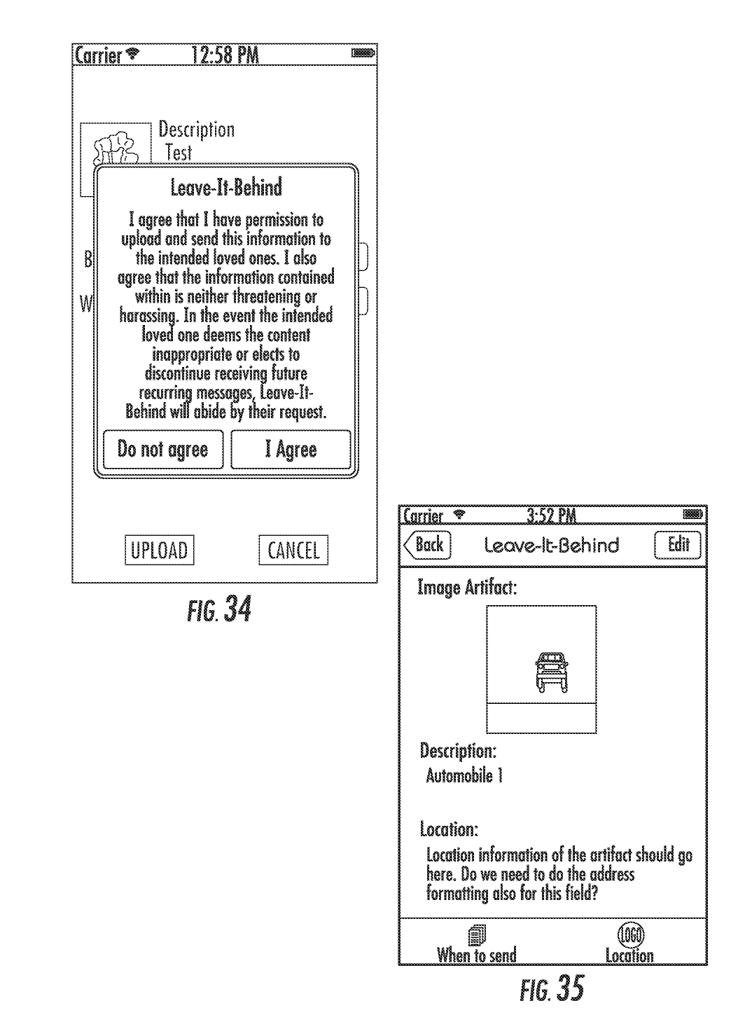

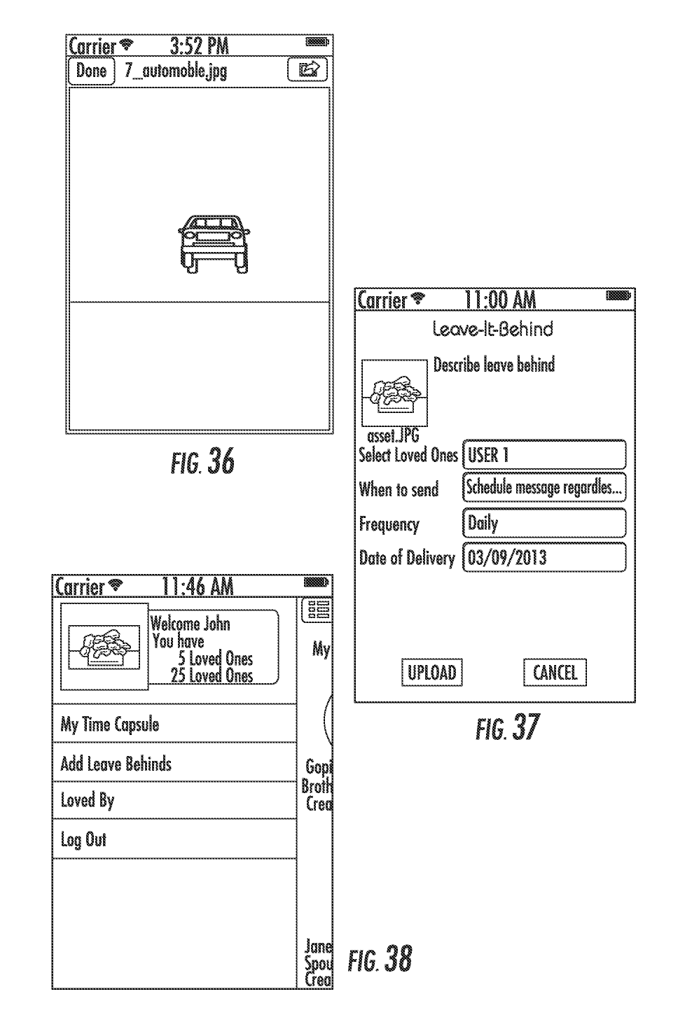

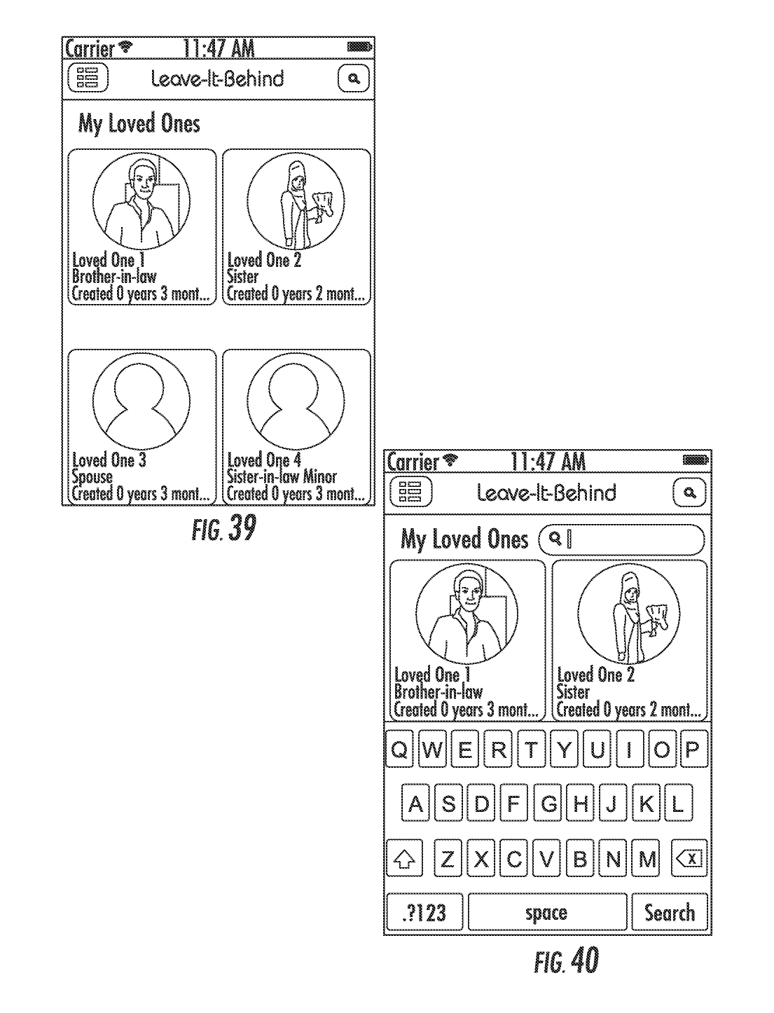

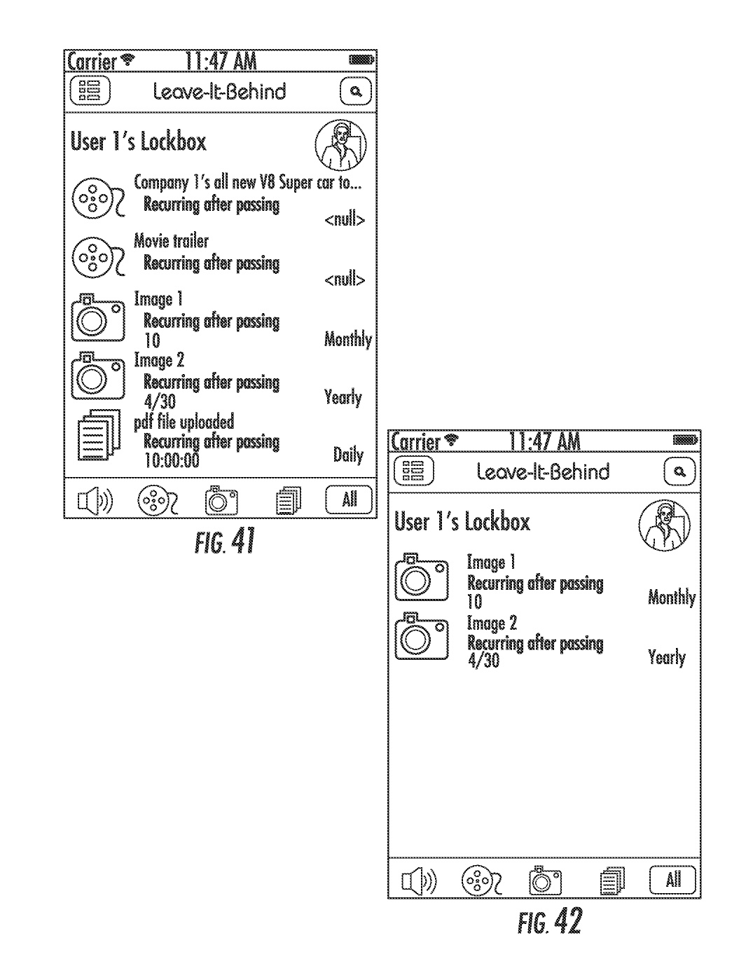

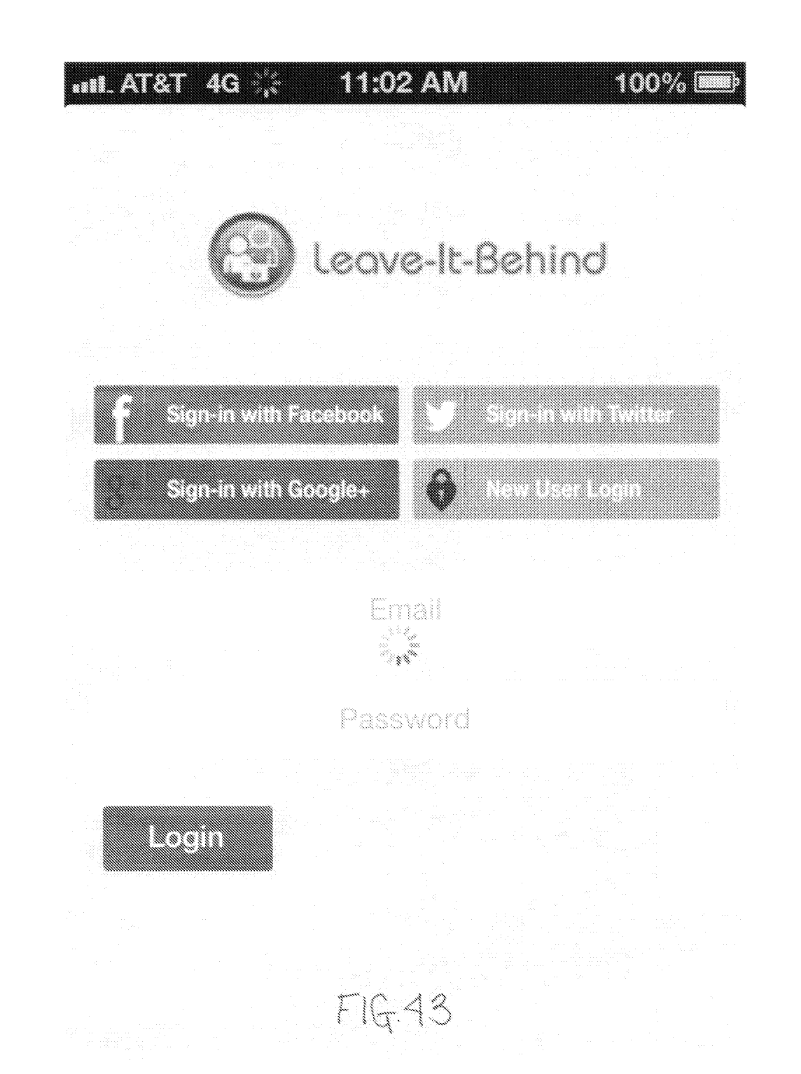

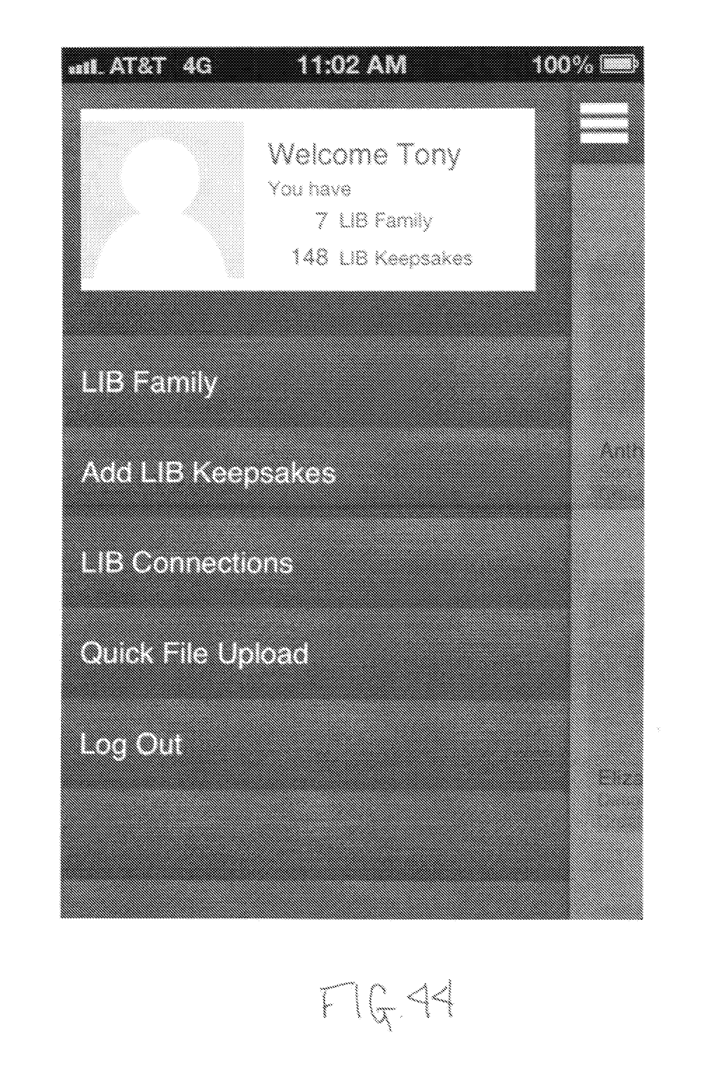

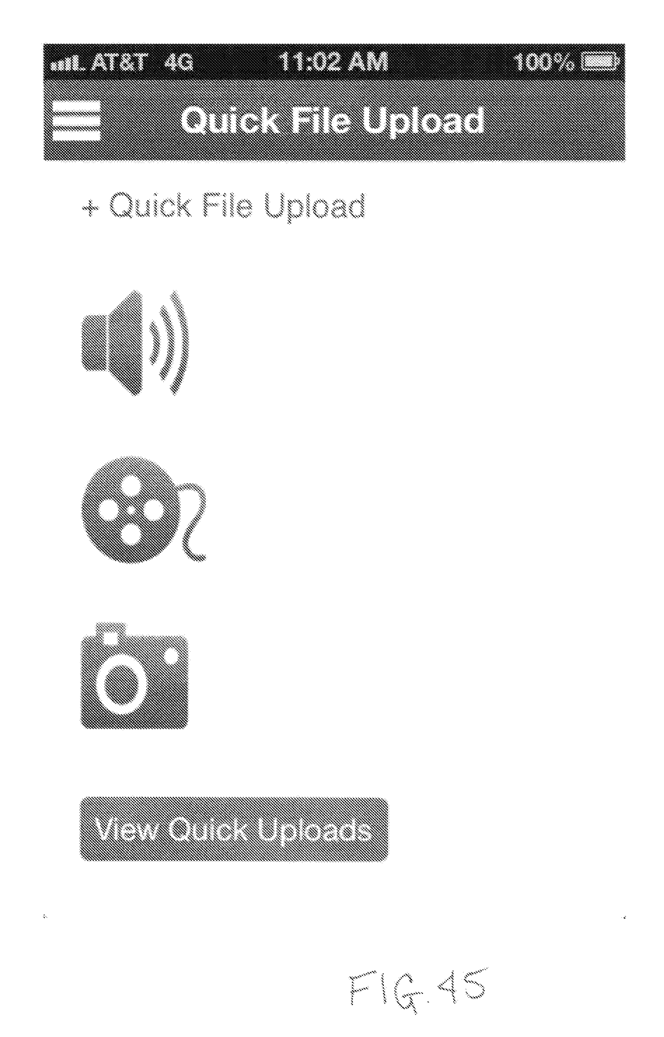

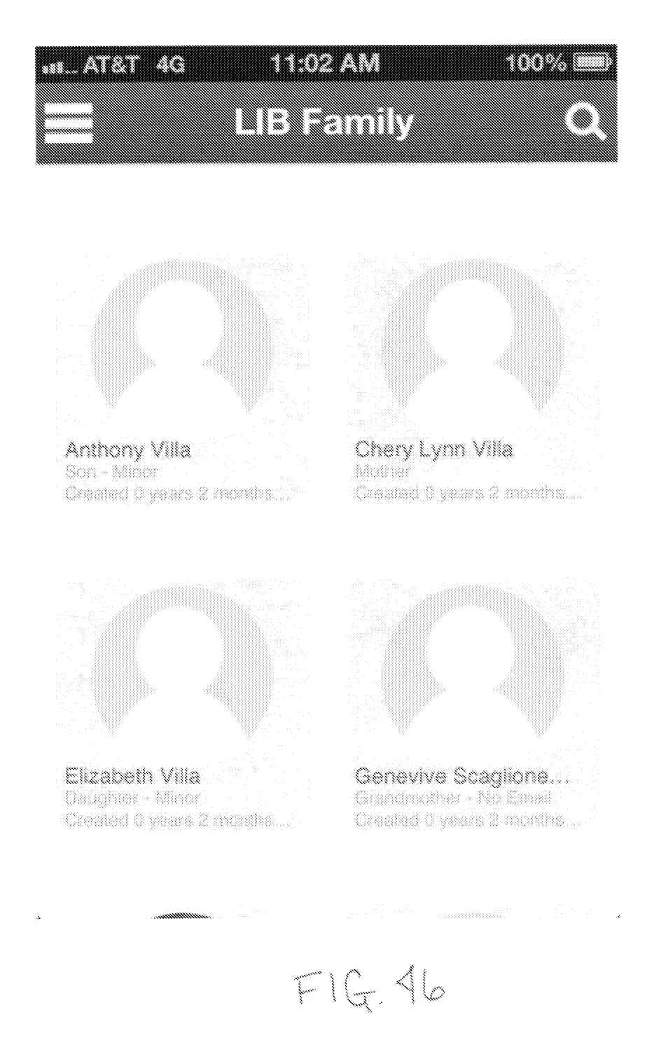

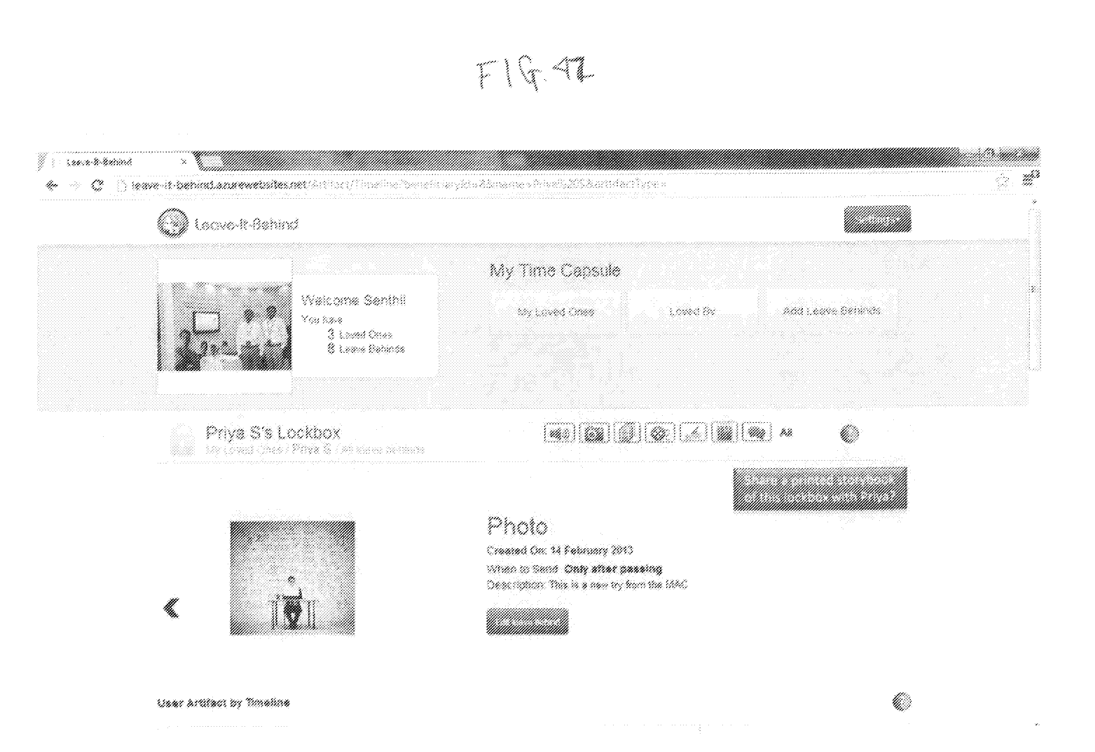

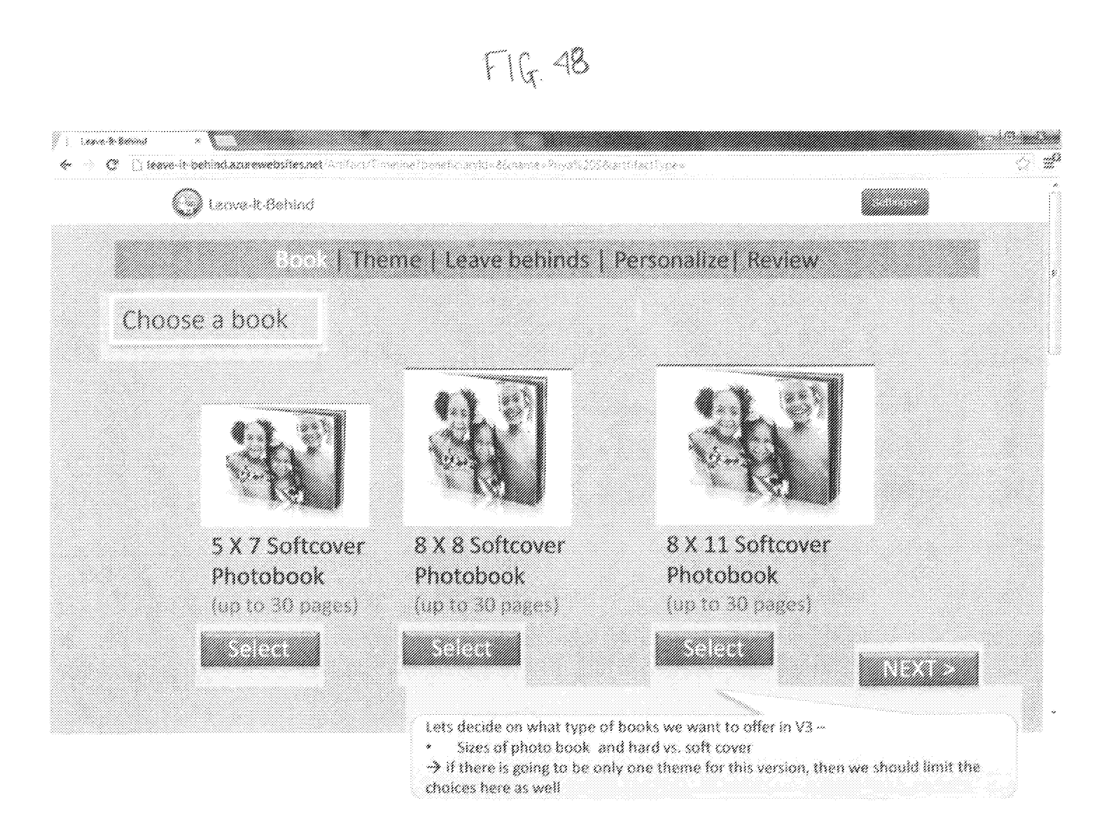

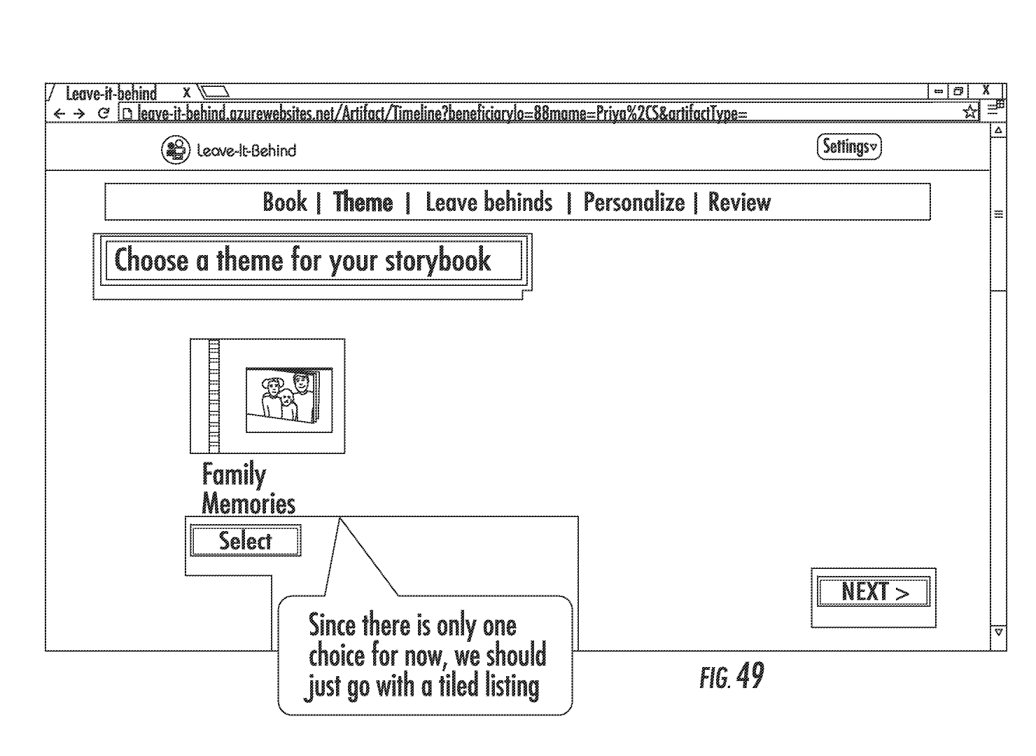

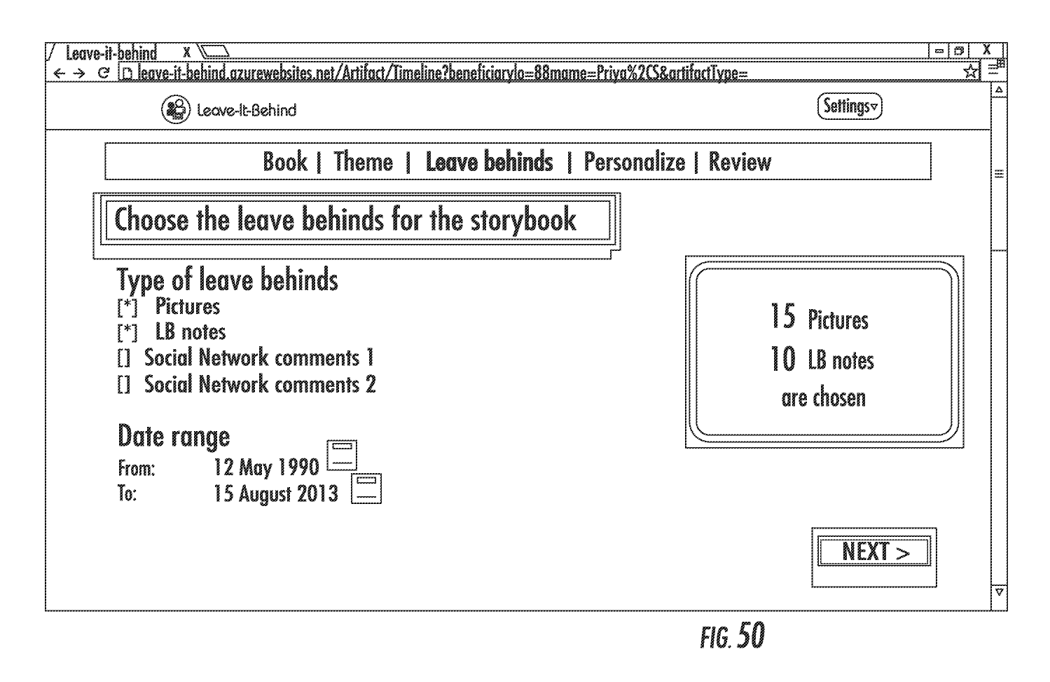

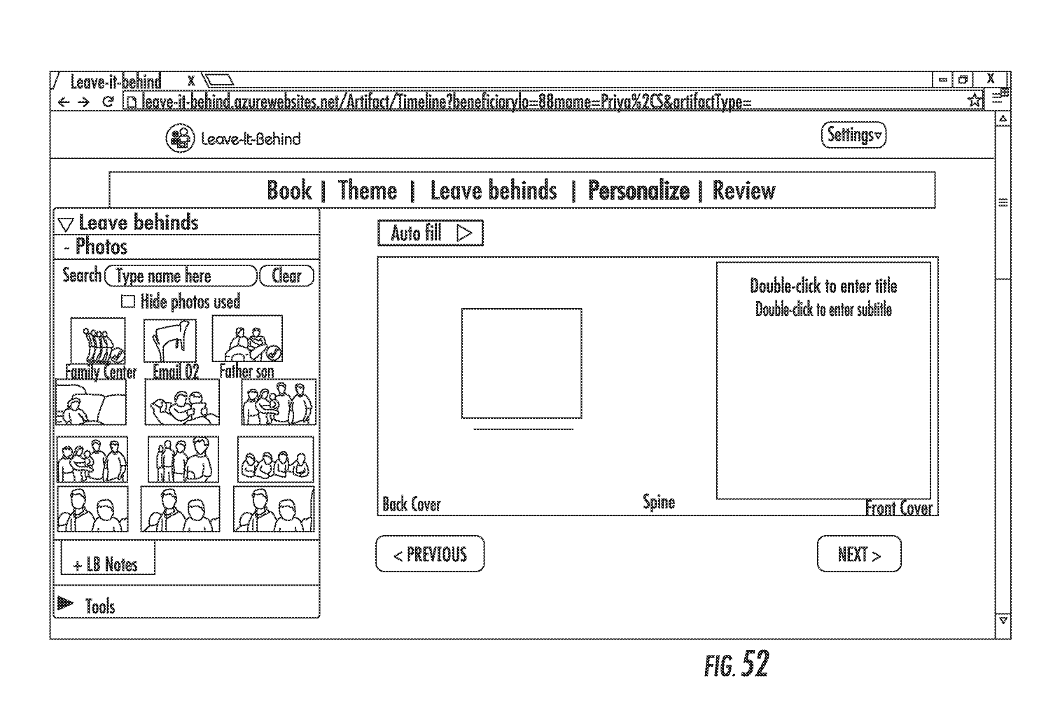

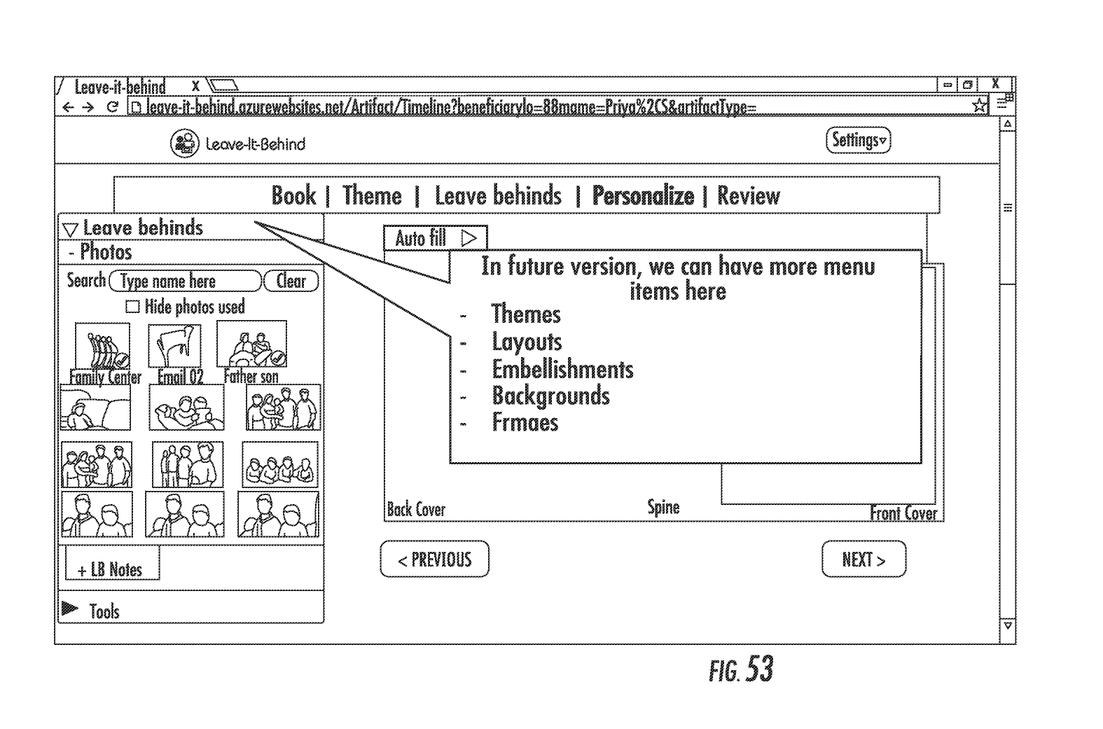

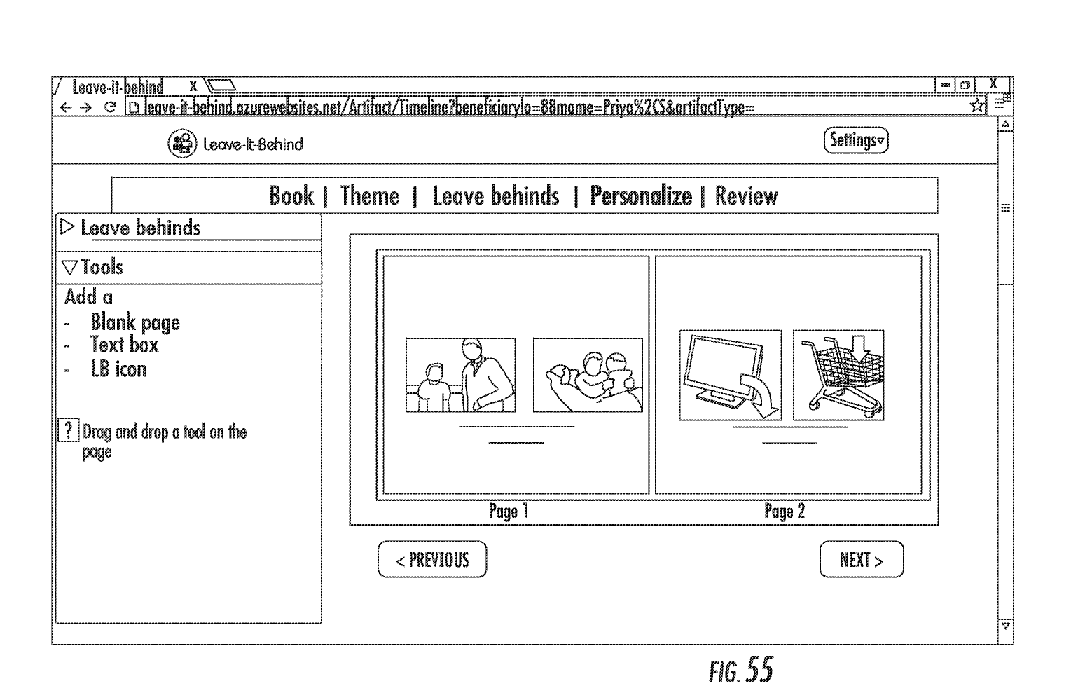

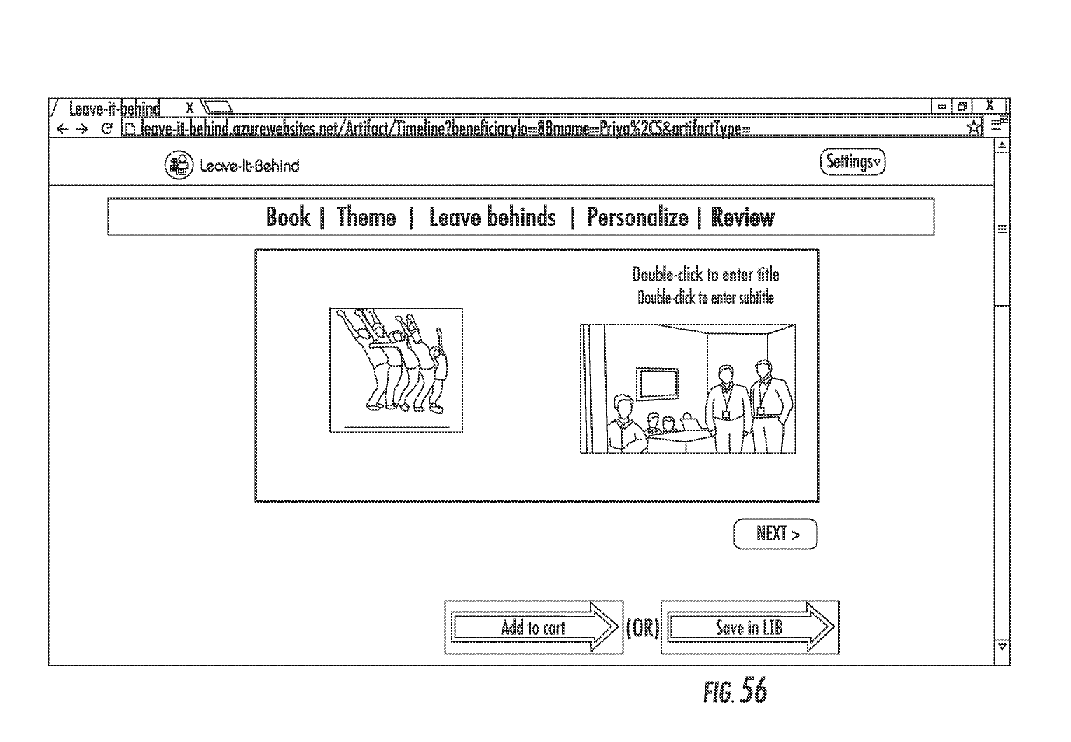

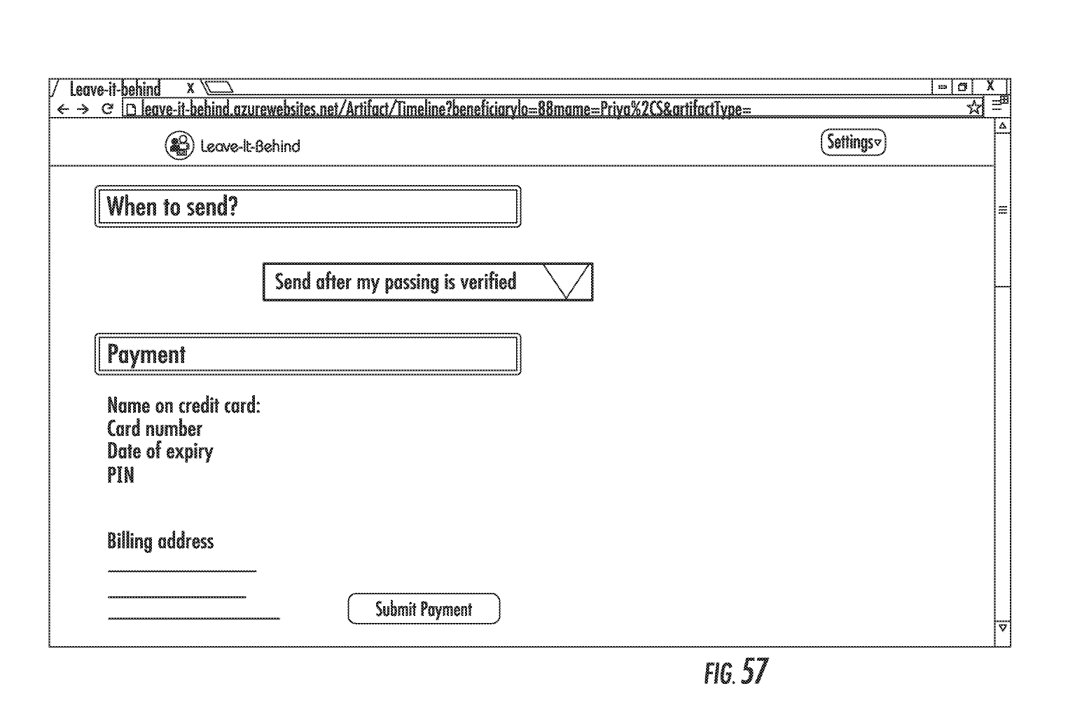

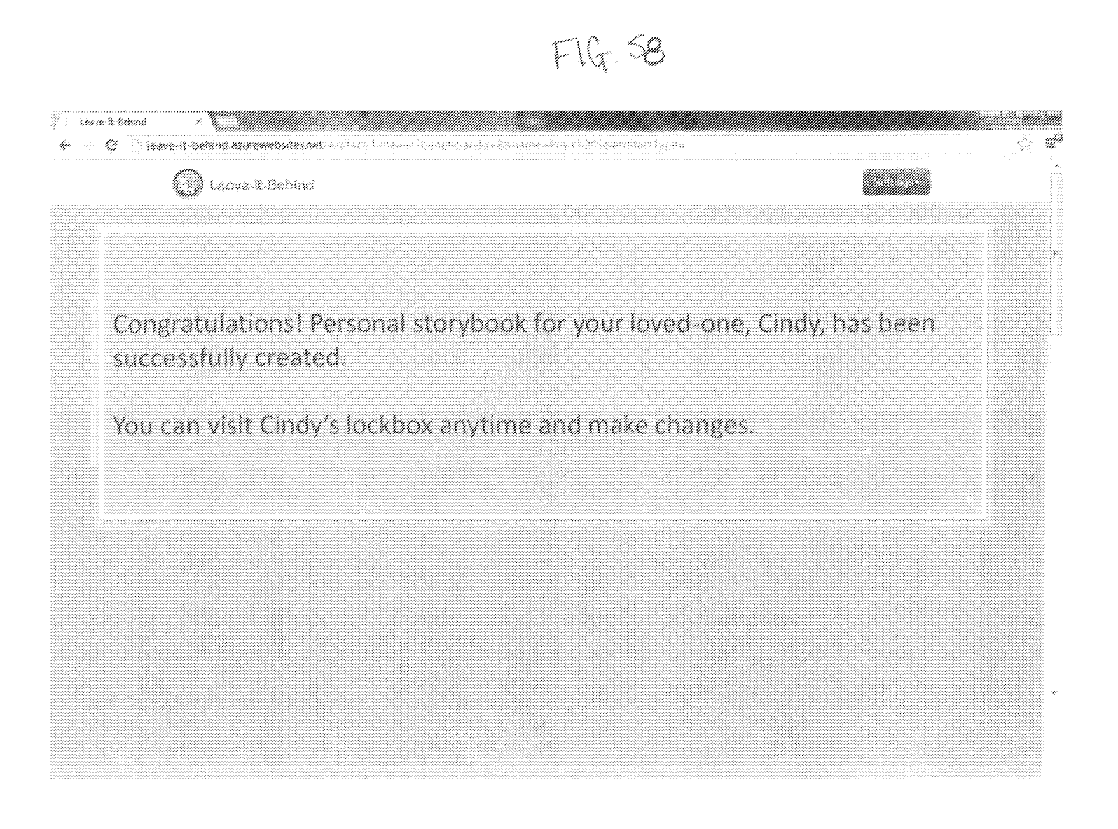

As shown in FIGS. 1-53, embodiments of the system and method are best understood through pages of a website and app screen shots which illustrate many aspects of the invention. The particular website (e.g., http://leaveitbehind.azurewebsites.net/home/home1) can be maintained as a pay or free service that enables members to privately catalog, store and share text based messages, pictures and video (collectively referred to as either “LIB Keepsakes” or “keepsakes”) with loved ones (referred to as either “beneficiaries” or “family”). Additional premium service offerings can be added. Maintaining the website as a free membership, at least initially, may facilitate maximizing the number of prospective users that will sign up and begin using the service.

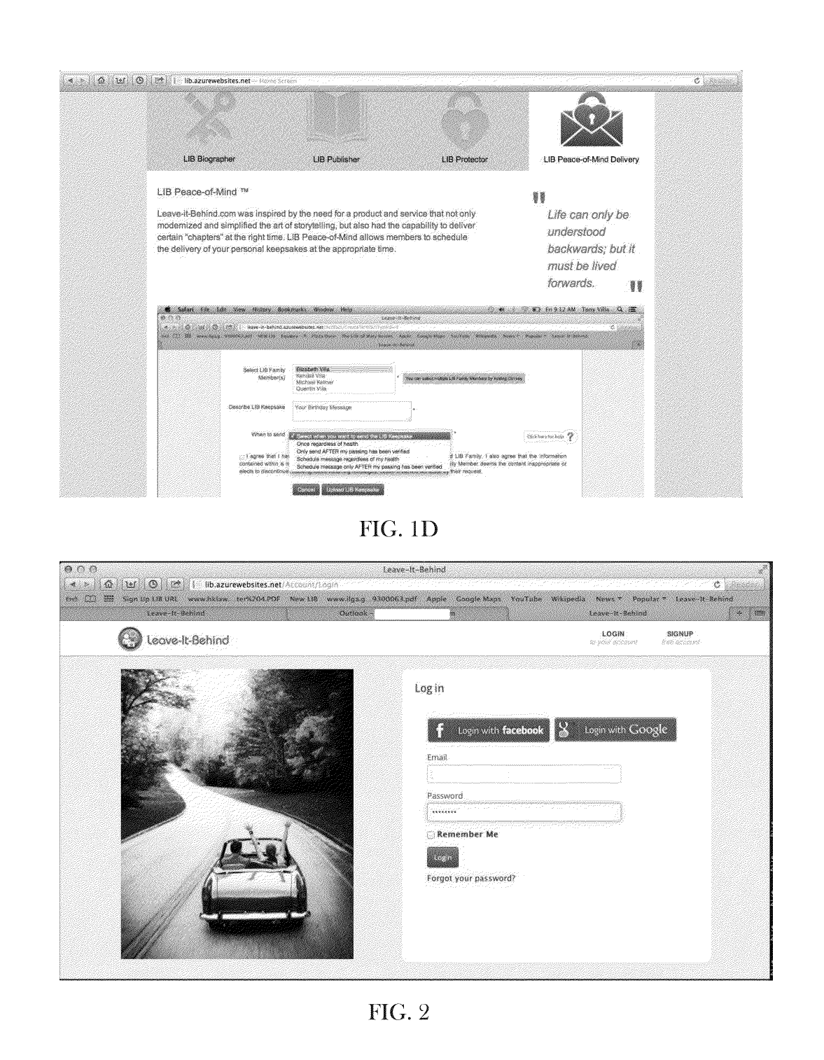

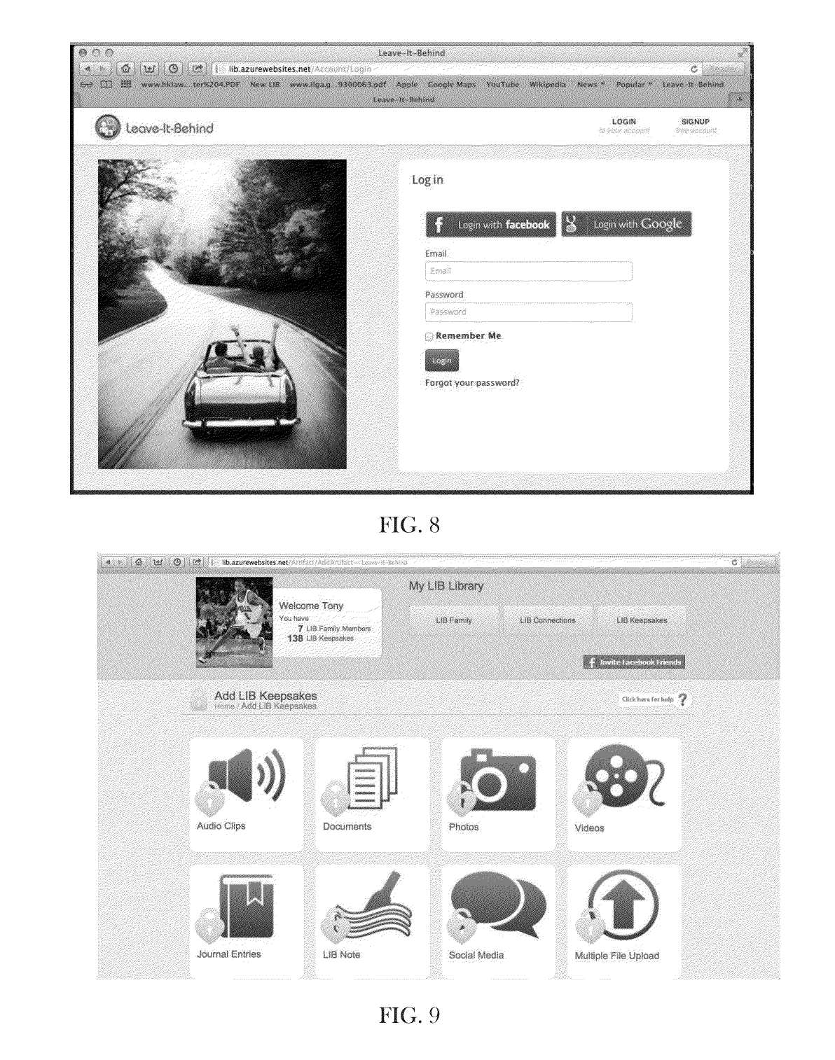

FIGS. 1A-1D illustrate a basic concept, including key features of the inventive electronic legacy system. The sign up process is intended to be simple. It may only require a name and email address to sign up. Once signed in at the “Log In” page as shown in FIG. 2, a user (also referred to herein as one of either the Leave-It-Behind.com (or LIB) member, subscriber, or user) can complete his or her profile in three simple steps. As shown in FIGS. 2 and 8, once registered, the user may be capable of signing in through a FACEBOOK®, GOOGLE®, or other linked account.

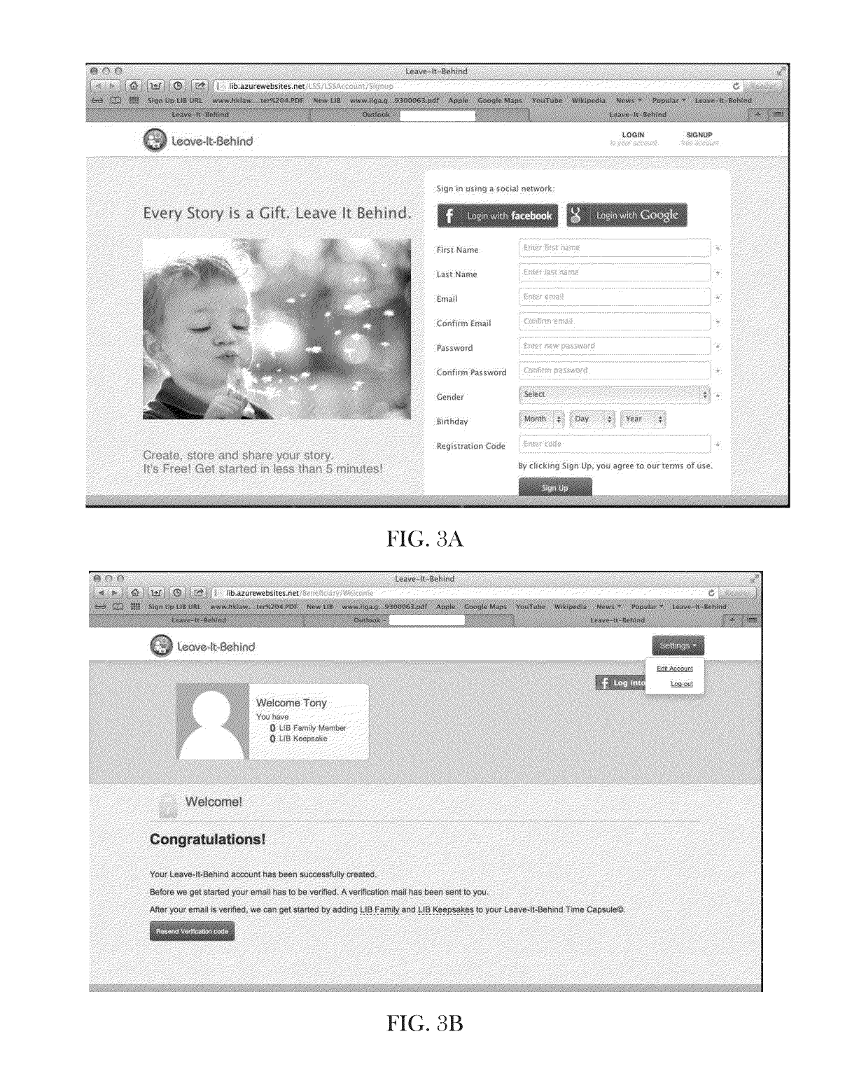

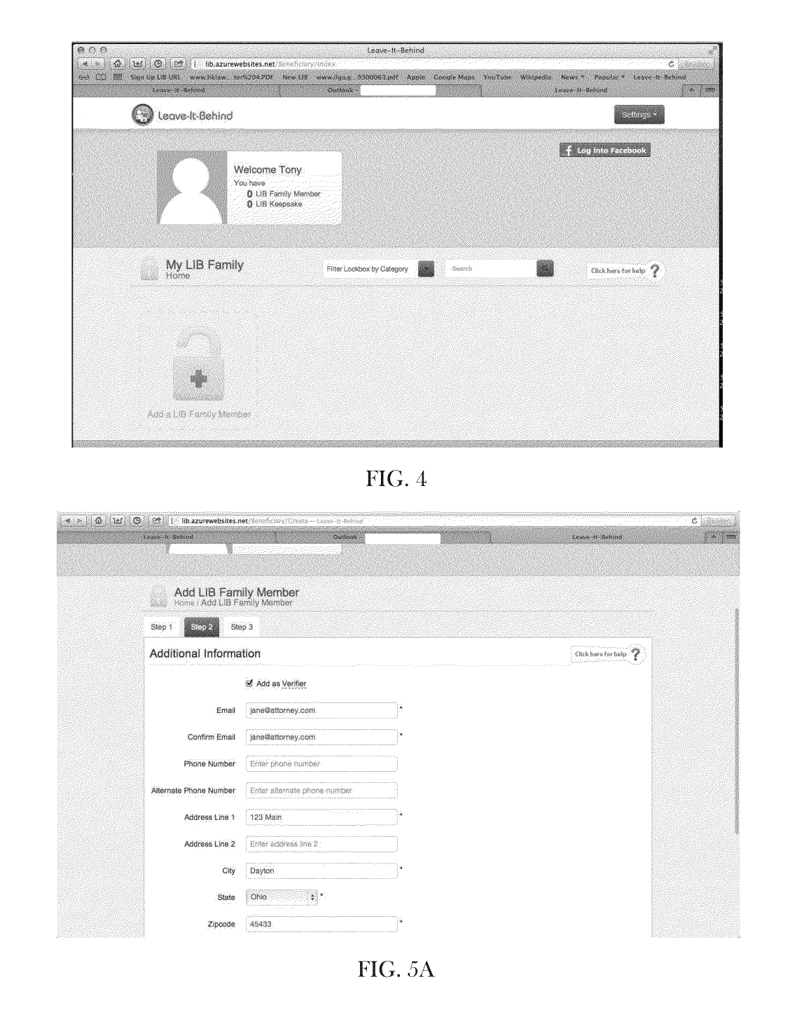

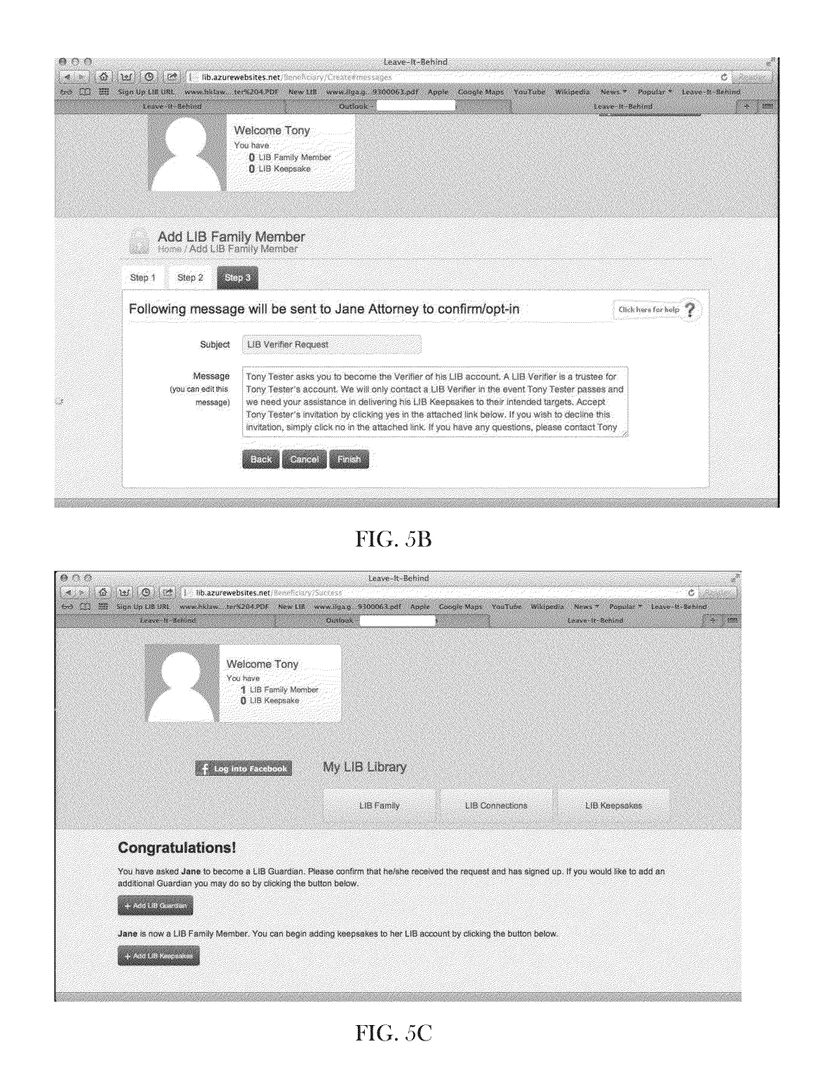

After a user logs in and creates a profile at the page as shown in FIGS. 3A-3B, Step 1 of the process begins and requires completing the verifier page. As shown in FIG. 4, the user begins by electing to add a “Family Member.” FIGS. 5A-5C show the profile requires the user to name at least one verifier. Each verifier may be confirmed via email and could be required to also complete a Leave-It-Behind.com sign up. Verifiers are responsible for confirming the passing of the Leave-It-Behind.com member. FIG. 4 illustrates a link for the verifier page (“Verification Process”).

Step 2 of the signup process enables the user to begin adding beneficiaries. Typically, each user starts with just one beneficiary, but following signup there are an unlimited number of beneficiaries that can be named. Beneficiaries are the intended recipients of digital LIB Keepsakes assigned by the Leave-It-Behind.com subscriber. Each beneficiary is contacted with a personalized email explaining the site and requiring them to also complete a Leave-It-Behind.com member profile, as shown in FIG. 3 again.

The final signup step is Step 3, assign an LIB Keepsake (see FIG. 9). An LIB Keepsake is a digital asset of the Leave-It-Behind.com member. An LIB Keepsake can be as simple as a text message, document, picture or even an audio/video file. Each LIB Keepsake is stored in the Leave-It-Behind.com member's LIB Library. A unique feature of Leave-It-Behind.com's LIB Keepsake storage/assignment process is that future messages can be delivered post-mortem, or essentially from “beyond the grave.” For example, the Leave-It-Behind.com member can set up a recurring LIB Keepsake, in this case an e-mail, that will go to his daughter on her birthday every December 31^{st}. So that even after he's passed, his daughter will receive a happy birthday email from her father.

In an embodiment of the system, the user has the ability to assign LIB Keepsakes to beneficiaries AND select how/when those LIB Keepsakes will be automatically distributed at a future time or times.

After completing Step 3, the new Leave-It-Behind.com member receives a message indicating that they have successfully completed the registration process and is re-directed to their LIB Library. At the time capsule, the first time user will see that they have one LIB Keepsake, one LIB Family member and one verifier. They can choose to add more of each of these by simply clicking on the add button under each category. They can also edit any information via this screen. From sign up to adding verifiers, LIB Family members and LIB Keepsakes, the process can be completed in very little time (in some cases, in as little as three minutes).

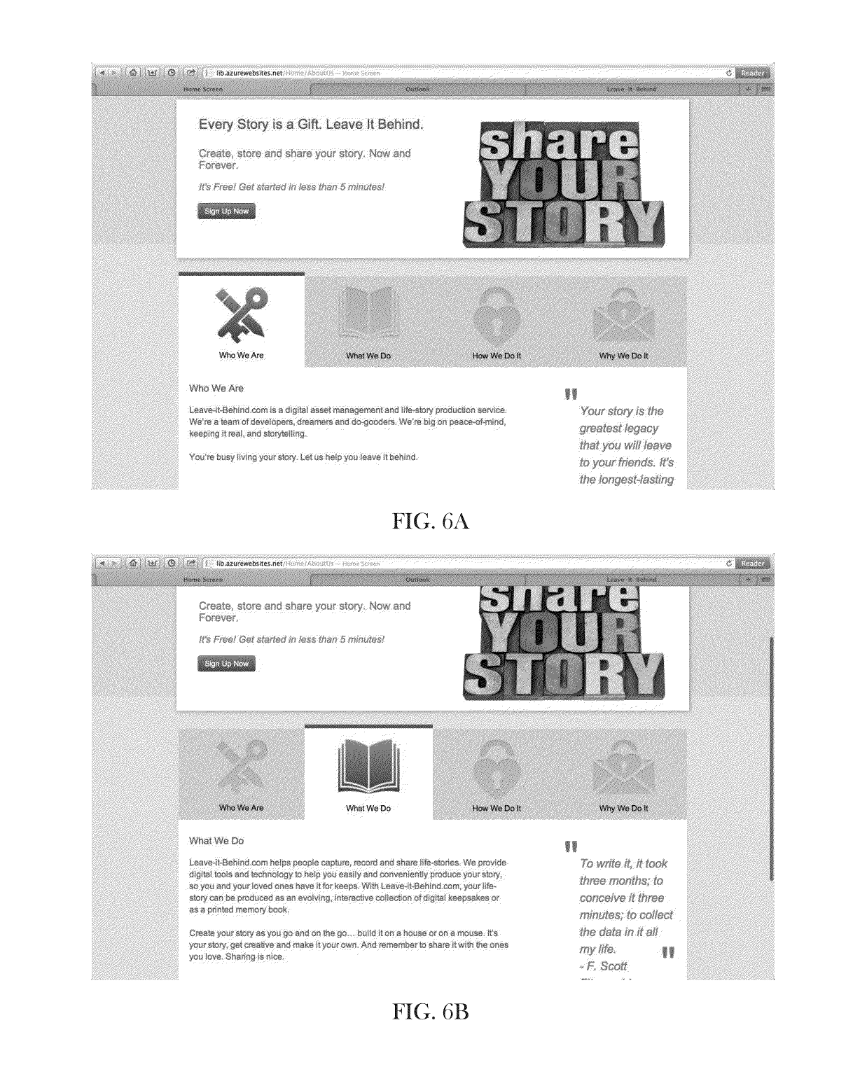

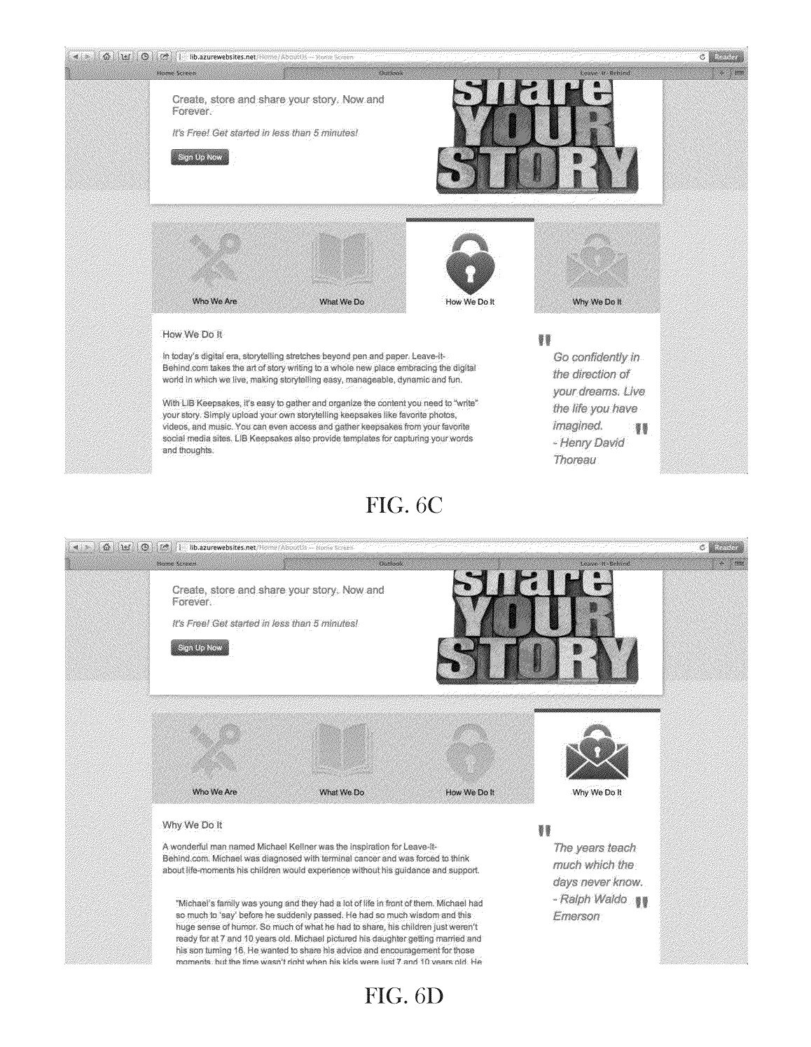

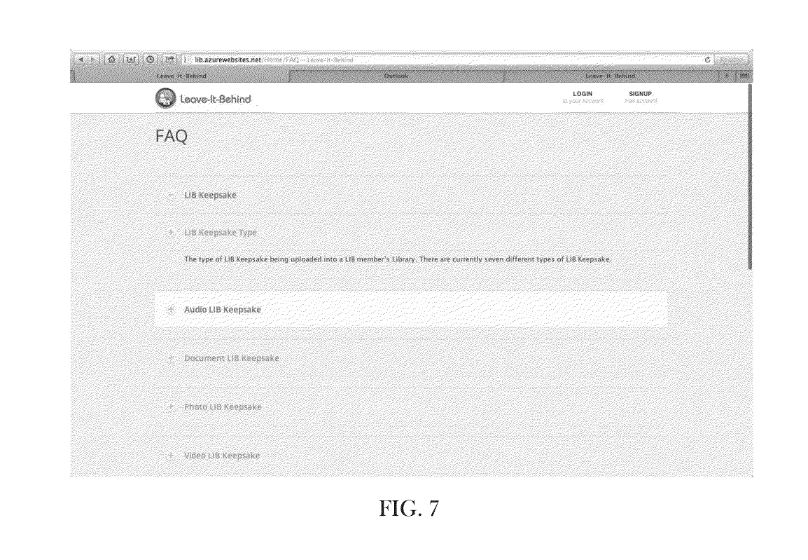

As shown in FIGS. 6-7, on a preferred program the website may include other functionalities.

Throughout the specific embodiments of the web-based system, 92 administrative tools are provided which can be used to help the LIB user/member record and store keepsakes for the future. Such administrative tools are described in further detail below.

### LIB Biographer™

LIB Biographer™ allows the LIB user to create and save detailed entries. If the idea of writing one's life-story drums up visions of endless days in a dusty attic, with a clunky typewriter and sweaty brow, LIB Biographer™ will put your mind at ease. The disclosed system takes the pressure off of “writing” by allowing members to easily upload existing, personal keepsakes like photo, video and audio files—as well as create original keepsakes using custom templates. No pressure, no sweat . . . just the glory of a story and the peace-of-mind that comes with knowing it's ready to pass on to loved ones.

In today's digital era, storytelling stretches beyond pen and paper. The present system takes the art of story writing to a whole new place embracing the digital world in which we live, making storytelling easy, manageable, dynamic and fun. With LIB Keepsakes™, it's easy to gather and organize the content needed to “write” your story. Simply upload storytelling keepsakes like favorite photos, videos, and music. Accessing and gathering keepsakes from favorite social media sites is also available. LIB Keepsakes™ also provide templates for capturing a LIB user's words and thoughts.

From this page a user can add additional keepsakes, by clicking the ‘Add LIB Keepsakes’ button. The user is directed to a new screen that shows the various types of keepsakes that can be captured. Currently, there are eight broadly defined options for adding keepsakes: Audio Clips, Documents, Photos, Videos, Journal Entries, LIB Notes, Social Media and Multiple File Upload. As discussed earlier, LIB users have the ability to archive and catalog previously uploaded social media assets using LIB tools.

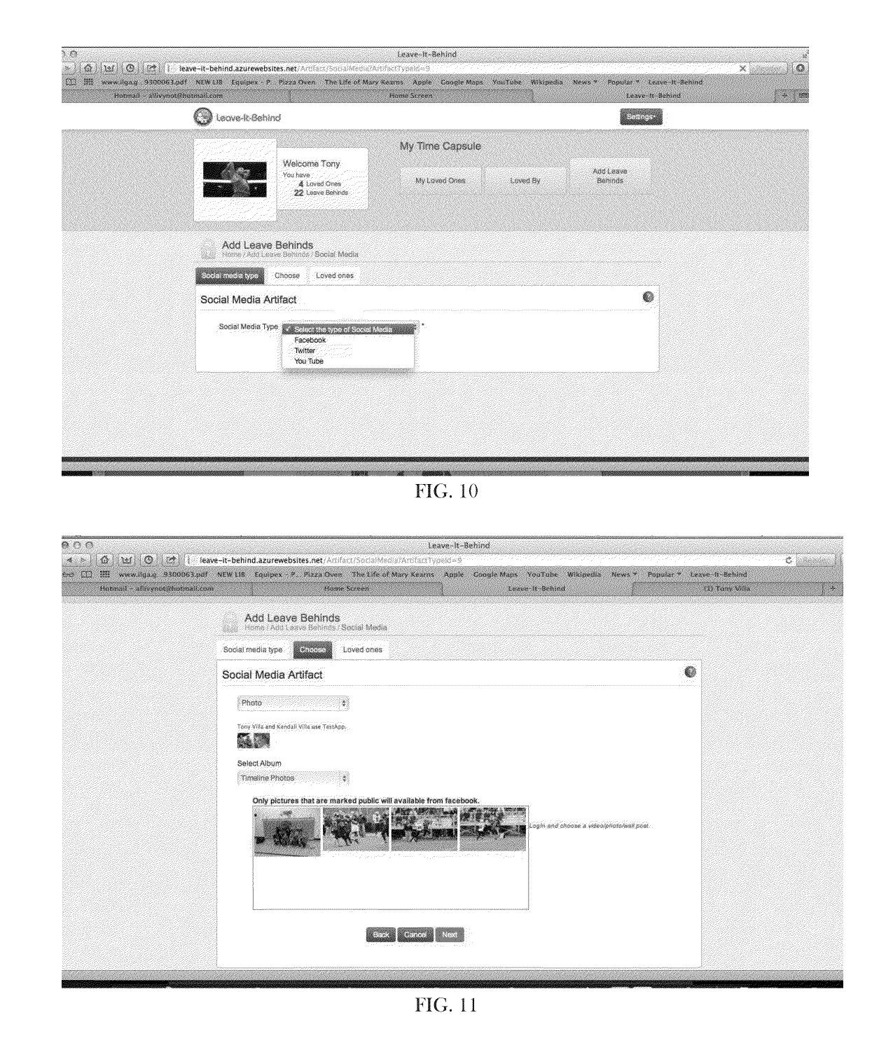

When the LIB user selects a Social Media keepsake, the LIB user is guided through a process that currently allows a user to move previously uploaded FACEBOOK®, TWITTER™ and YOUTUBE™ content to their LIB Library (see FIG. 10). Additional integrations with other social media and photo-sharing websites, e.g., INSTAGRAM™, FLICKR™, SHUTTERFLY™, etc., may also be provided.

After determining the social media or other website, the user is guided through a process that enables them to choose content from any number of websites. The example of FIG. 11 illustrates how the FACEBOOK® integration works with photographs a LIB user has stored on his timeline.

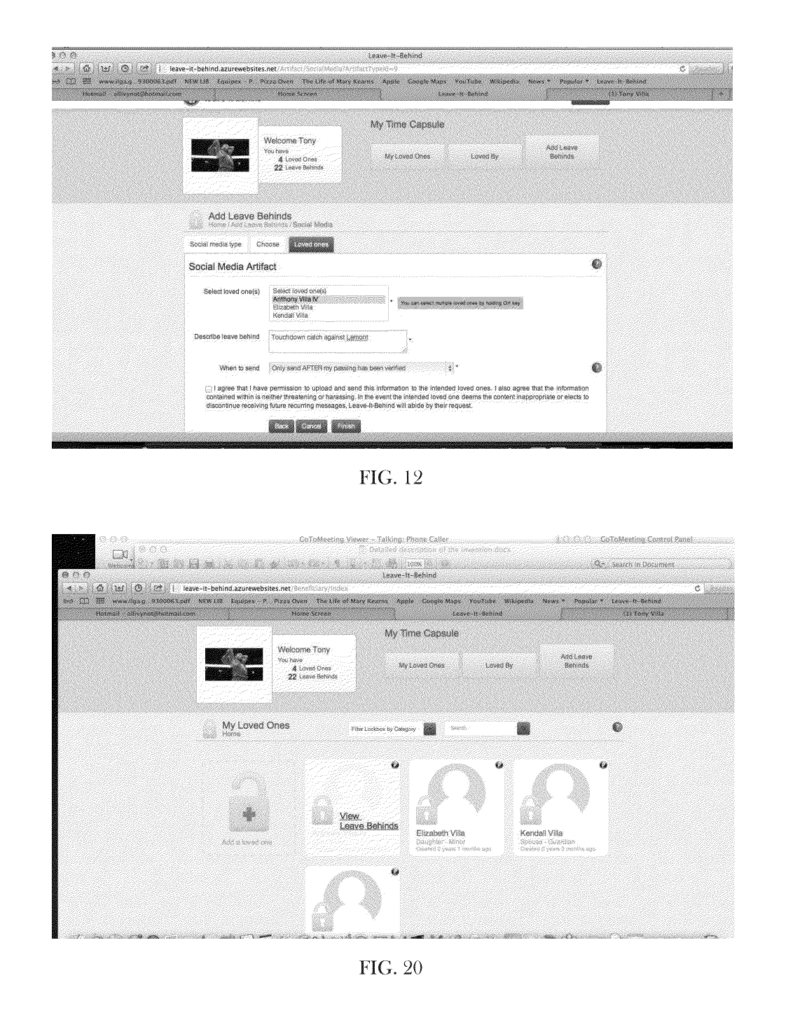

Upon selecting the appropriate picture, the user is also asked to assign the social media content to a LIB Family member and determine when the content should be shared with that LIB Family member (see FIG. 12).

The process can be simple and efficient. Equally important, the process may be the same for each of the social media websites referenced, as well as the other keepsake types. This allows the LIB user to easily gather and catalog all of their digital assets. Moreover, it allows the LIB user to systematically determine when to share all these moments with the appropriate LIB Family member.

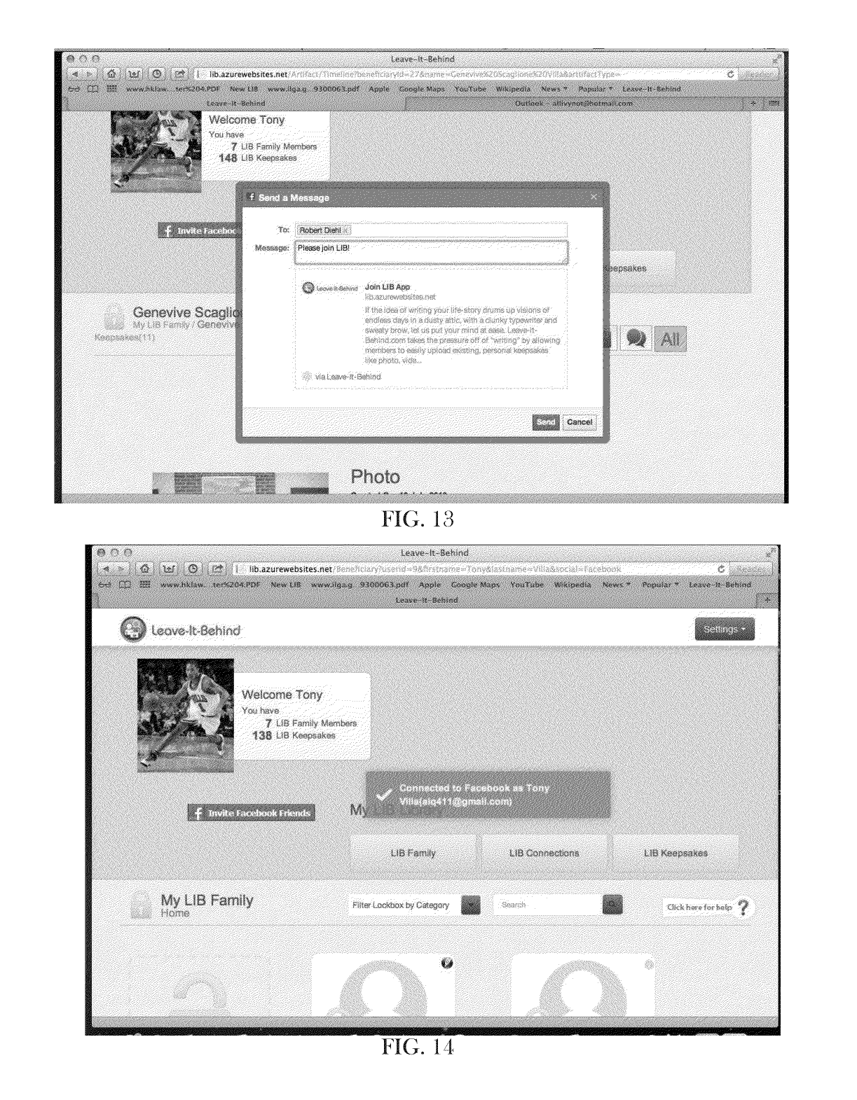

As illustrated in FIGS. 13 and 14, additional features of the social media integration may include the ability to link to, e.g., FACEBOOK® friends without having to exit the application and look up contact information. This integration will make it easier to select friends as LIB Family members. Further, the LIB system may be integrated to, e.g., FACEBOOK® or other social media and photo share sites so that a user may be prompted upon uploading, saving, or exiting whether certain items can be used in LIB as a leave-behind LIB Keepsake. Selecting “yes” could execute start up of the members personal LIB webpage with the specific designated item waiting for assignment.

### LIB Keepsakes™

Whether you're creating a story or protecting digital assets, LIB Keepsake™ tools allow you to access and upload content to your LIB Library™. As discussed earlier, some of the content may already exist via files on other social media websites or the user's computer hard drive. Additionally, the LIB System provides templates to help the user document their life story. LIB Notes are templates that may prompt the user to document new content that is specific to a life lesson learned or milestone event in one's life.
Audio Files
Photo/Jpeg Files
Video Files
Social Media Assets
Documents
Journal Entries
LIB Notes

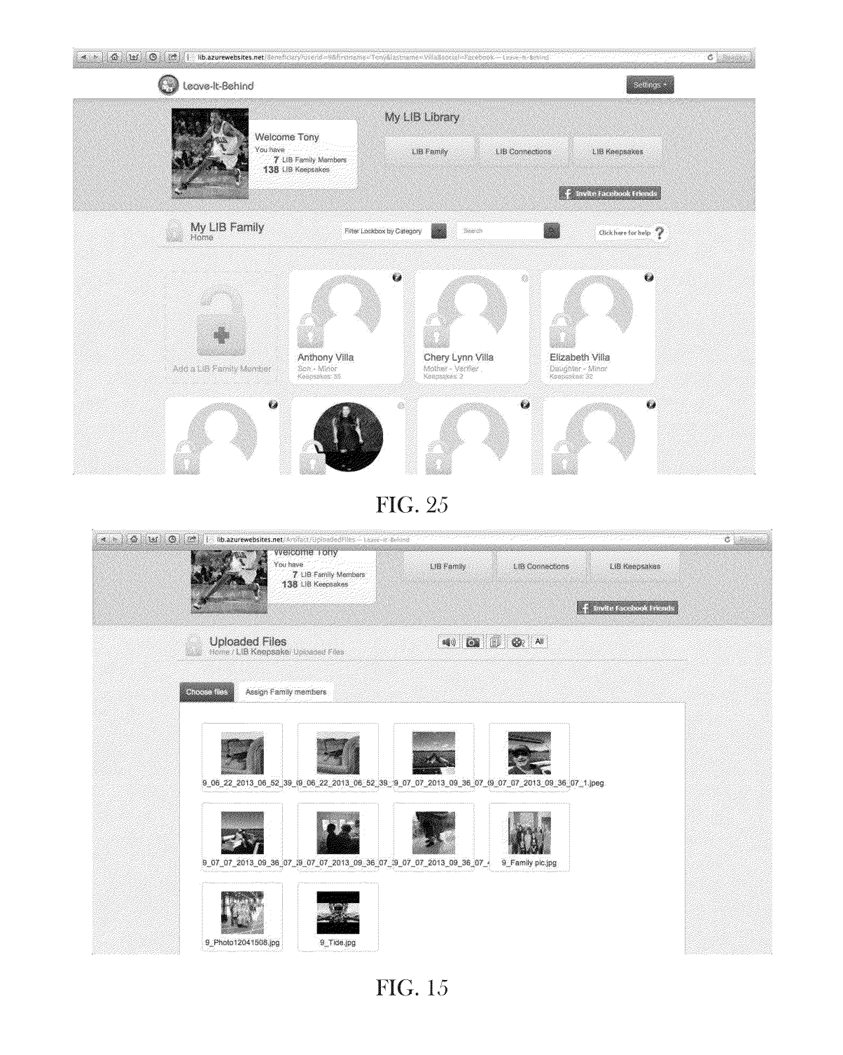

FIGS. 15-19 illustrate the step-by-step process for choosing keepsake files (photos in the illustrated example) from a resident database or memory, selecting a LIB family member/beneficiary to receive the keepsakes, determining when the keepsakes should be delivered, and finally adding the keepsakes to the selected member's LIB Library. The system has no restriction on how many keepsakes can be added or later edited.

Further, the iLIB™ mobile app can be downloaded to a smart phone or tablet to help document and tell a user's story on the go. The iLIB™ app is discussed in further detail below.

### LIB Publisher™

LIB Publisher brings a user's story to life as a digital timeline or printed keepsake. For each story created, LIB Publisher automatically produces a dynamic timeline. The timelines provide an expandable and collapsible digital snapshot of keepsakes in date order. The personal keepsakes that make-up that story can also be converted to a printable storybook.

After repeating the process of uploading and assigning keepsakes to LIB Family members, the user can begin assembling a visual representation of those shared moments using LIB Publisher™. As shown in FIGS. 20, 21 and 22, by returning to the LIB Library™, the user can click on any particular LIB Family Member to see a visual representation of all the keepsakes saved for that individual. Once a particular LIB Family™ member is selected, a dynamic timeline is published for that particular user showing all of the selected LIB Family™ members digital assets in chronological order. The timeline is expandable and collapsible by the LIB user. The LIB user can also sort by keepsake type (e.g., photos, videos, documents, etc.) to only see a particular type of keepsake. Moreover, the LIB user can also sort by date parameter if they only wish to see a particular time period.

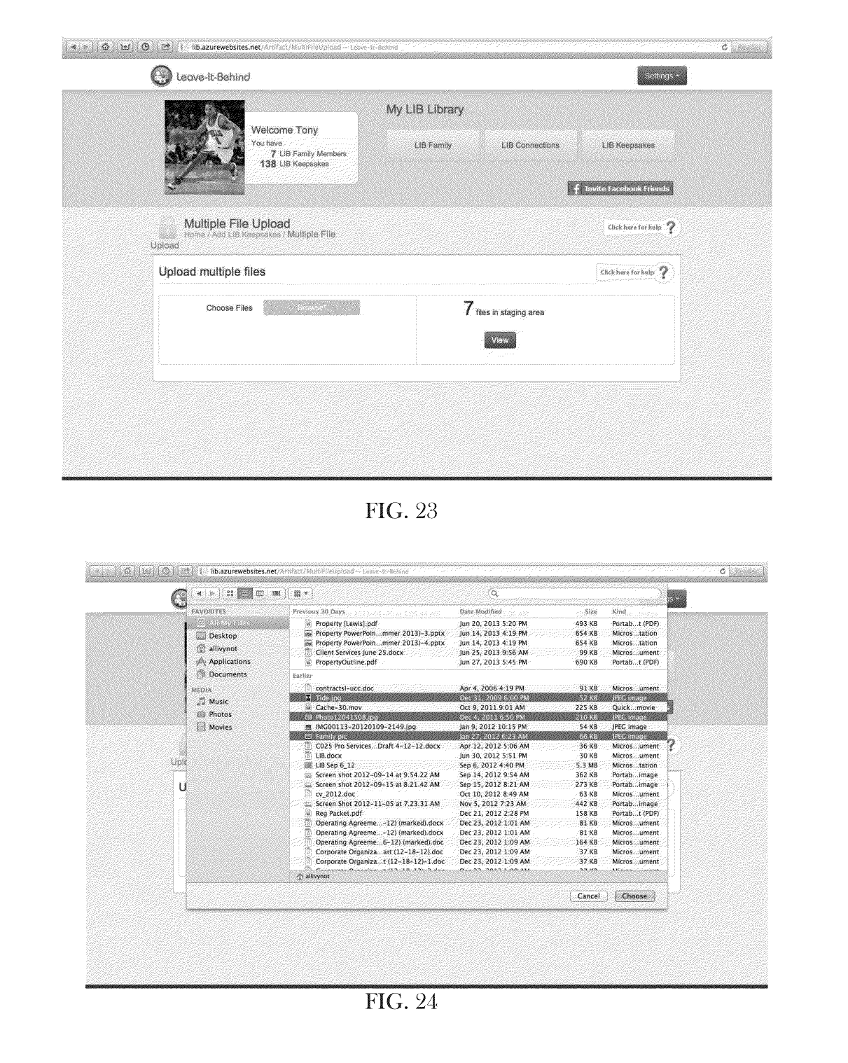

Another tool shown in the LIB Publisher feature is called “Multiple File Upload.” As shown in FIGS. 23 and 24, this tool allows a user to choose multiple files from a camera, computer, or other electronic storage device, and upload them to a staging area within the user's LIB Library. However, the user doesn't have to assign them at that time to a LIB Family Member. It is an even simpler upload process because the user only has to select the files to be uploaded and then execute the process, for example, by clicking on “upload”. This feature is useful when a user captures a many pictures on a camera phone but does not have time to catalog them in the LIB System. The multiple file upload insures that the pictures are available in their account and can be cataloged at a future time.

Similar to the multiple file upload feature, the system may incorporate a synchronization process. The synchronization feature would allow users to set up a LIB folder and schedule a time for any file in that folder to be ‘dropped’ into the same staging area that is used for the multiple file upload. Again, the focus of this feature is ease of use and making sure that all files earmarked for a user's LIB account find their way into the staging area with as little effort as possible.

From here a LIB user can easily view a particular keepsake or edit any keepsake previously stored. Additionally, a user will be able to generate a tangible storybook keepsake using the LIB Publisher™ tool and the LIB Storybook™.

### LIB Protector™

Beyond the creative (and fun) art of storytelling, Leave-it-Behind.com functions as a practical alternative to digital safekeeping of (not-so-fun) documents and assets like life insurance policies and wills, account information and passwords. It's important to know that LIB Protector™ safely and securely stores those critical documents and passwords you need to have prepared just in case. Did we mention we're big on peace-of-mind?
Protect and secure life insurance policies, wills and trusts
Protect treasured keepsakes like artwork, schoolwork and report cards
Protect bank and investment account information and passwords
Protect Social Media Passwords

Following the sign up process, the LIB user leverages LIB Protector™ to begin aggregating all of their digital assets. LIB Protector™, a screen shot of one embodiment which is illustrated in FIG. 25, is essentially a unique data repository or LIB Library™ for each LIB user. Each time a LIB User logs in, the user is taken to their LIB Library (may also be referred herein to as “Time Capsule”). This page serves as the library for all of the LIB users digital assets and highlights the number of keepsakes (also referred to as LIB Keepsakes and leave behinds) uniquely assigned to their LIB Family members (also known as beneficiaries, friends or significant others). LIB Protector™, and the LIB Library, addresses the need for a central location for all digital LIB Keepsakes.

### LIB Peace-of-Mind Delivery™

Leave-it-Behind.com was inspired by the need for a product and service that not only modernized and simplified the art of storytelling, but also had the capability to deliver certain “chapters” at the right time. LIB Peace-of-Mind Delivery™ allows members to schedule the delivery of a user's personal keepsakes at the appropriate time.

In a preferred embodiment, each LIB user would assign at least one verifier to their account. A verifier does two things: (1) accepts the responsibility of any digital assets assigned to a minor or a loved one without an email address, and (2) notifies the system administrators (e.g., those operating the website) of a users passing. Once notified of a passing, the death may be confirmed, for example, via a governmental database, such as social security, or by way of submitting a physical copy of a death certificate. Upon confirmation, the contents of a user's LIB Library may be delivered as specified.

For increased peace of mind, a user can assign as many verifiers as desired. Alternatively, a user may want to rely on Leave-it-Behind.com to act as verifier. In either event, neither an appointed verifier nor any LIB staff members should be permitted to see any keepsakes.

A key feature in LIB is the system's ability to systematically schedule the delivery of any keepsake type to any LIB Family Member. As shown in FIG. 26, the LIB Peace of Mind Delivery™ scheduling system provides the LIB user with the following choices of when to send a keepsake to a LIB Family member: once on a specific date regardless of health; once on a specific date only after the LIB User has passed away; on a recurring basis regardless of health; and, on a recurring basis only after the LIB User has passed away.

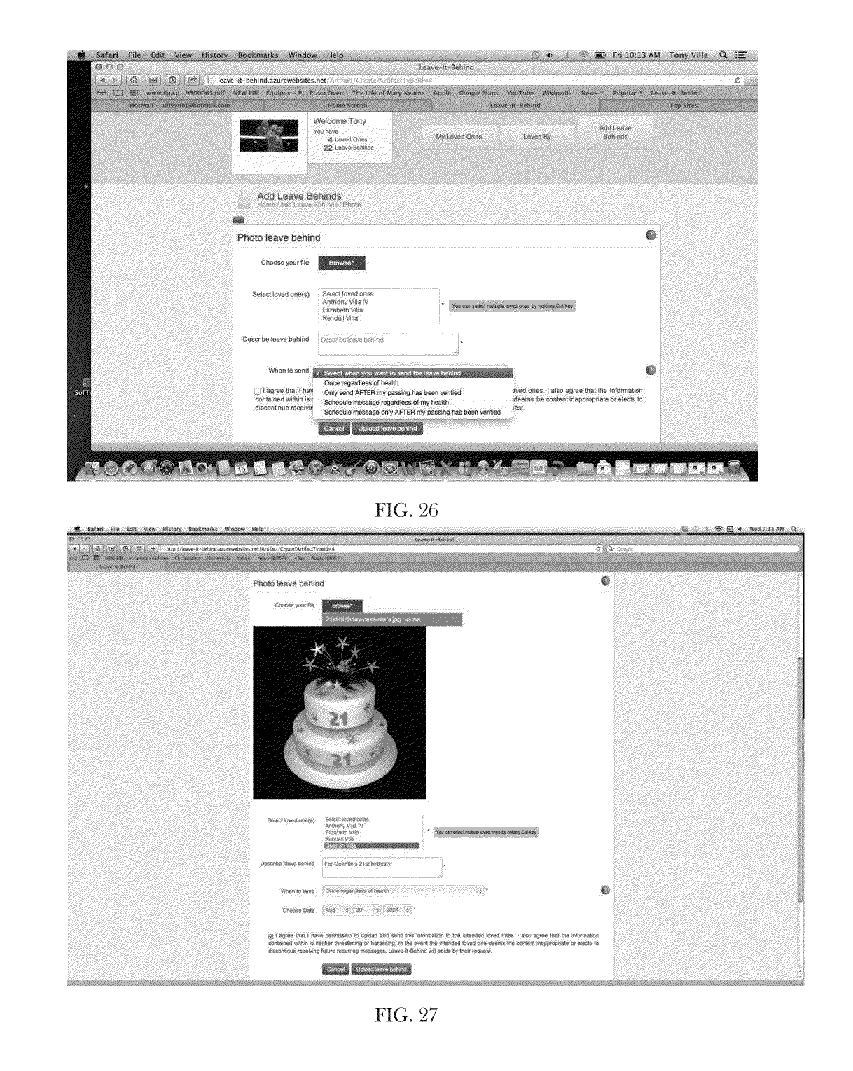

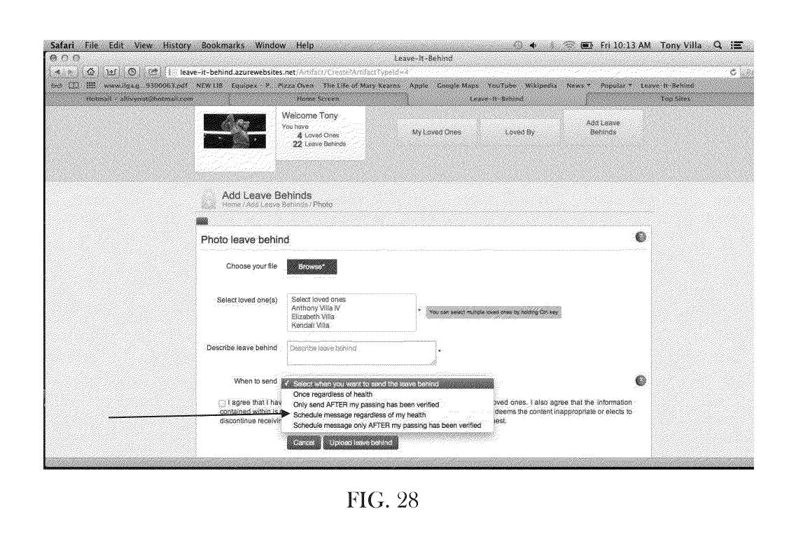

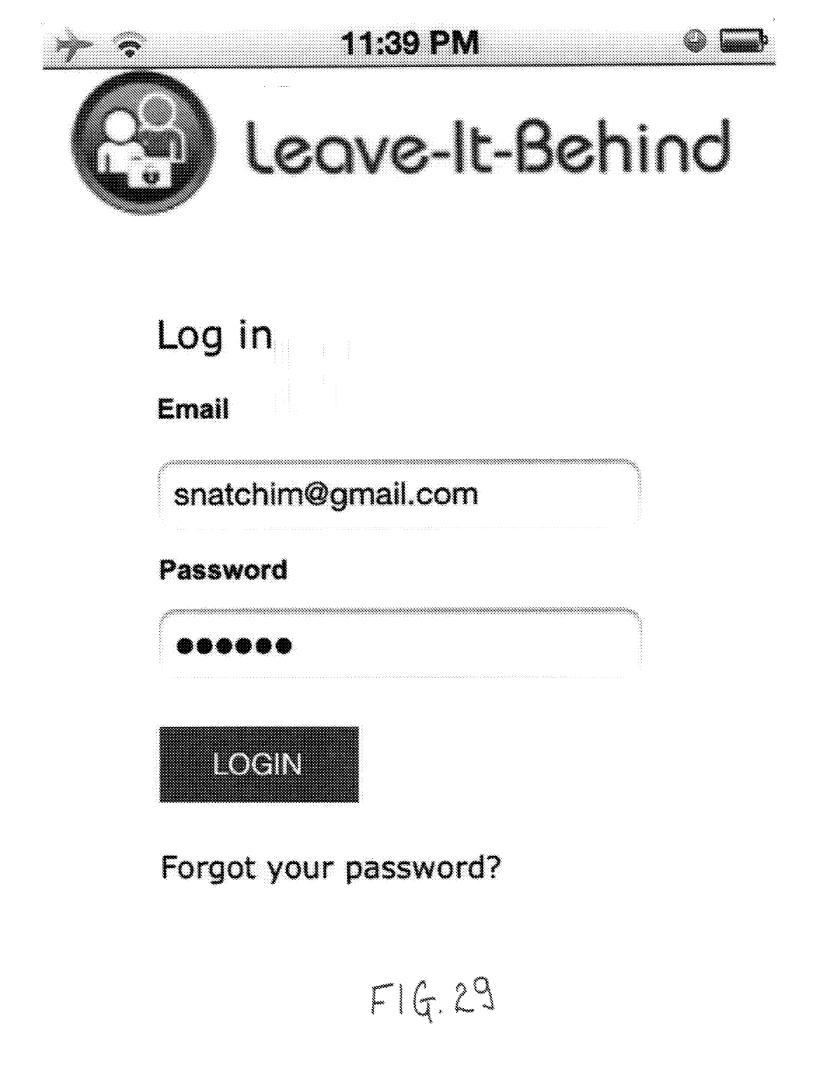

FIG. 27 illustrates a message which is to be delivered once on a specific date in the future. FIG. 28 illustrates the selection (see arrow) when a message is to be delivered on a recurring basis on a specific date regardless of the user's health.

Referring now to FIGS. 29-42, a member can also download and use a compatible app (iLIB) for a smart phone or similar electronic device (e.g., Apple iPad).

iLIB™ is one piece of functionality that is a major and true differentiator between Leave-It-Behind.com and other related systems and methods. Because keepsake moments don't always happen when users are near a computer, Leave-It-Behind.com has designed an app for a portable electronic device, e.g., the iPhone and iPad, that enable the user to capture spontaneous LIB Keepsakes via voice to text as well as photo capturing. Using iLIB™, the LIB Keepsake is automatically catalogued with a date, time and location. The user can then assign each LIB Keepsake to a LIB Family member.

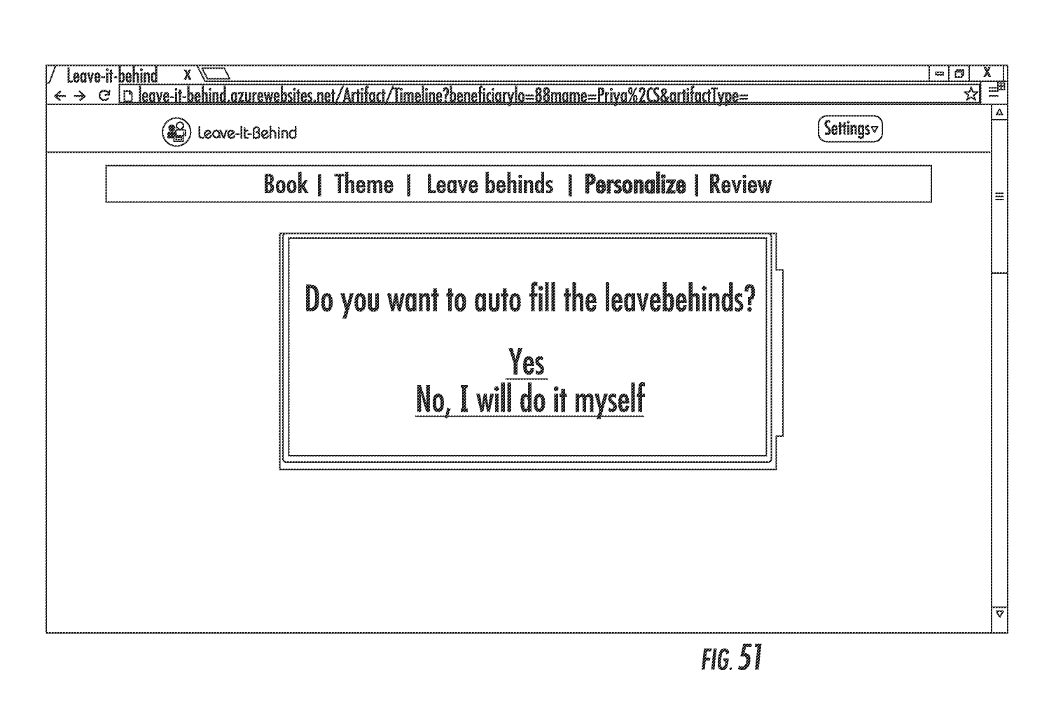

As shown in FIGS. 43-46, iLIB™ can use the same simplistic and intuitive design as the web. There is a user login in and password to start. Once successfully logged in, the member can add LIB Keepsakes and assign them to current beneficiaries. The app will also allow the member to add beneficiaries but it may be limited, such as not allowing the member to add verifiers or edit anything within the member's LIB Library. Such editing can be limited to the web-based program.

The disclosed system has a wide breadth of functionality. Today there are many competitors offering pieces of what the present system and methods can offer in a single package. For example, there are many services offering digital media archiving, legacy letter templates, online memorials, and last wishes videos. However, there is not a single system that combines all aspects of these services in a single, easy to use site.

Embodiments of the present system can offer members:
A personalized and secure digital vault (LIB Library);
An intuitive ability to name trustees (verifiers) of their account;
The ability to upload digital media (LIB Keepsakes);
The ability to catalog and assign LIB Keepsakes to beneficiaries (LIB Family members);
An automated means to disperse LIB Keepsakes to beneficiaries post mortem;
The option to send recurring, date specific messages to loved ones post mortem;
Templates to help document important life lessons and milestone memories (LIB Notes);
Celebrity video templates that will serve as an interview roadmap to simplify the capture of video LIB Keepsakes;
Automated prompts to encourage a user to regularly add to their life story;
A mobile app to insure the ability to document spontaneous moments;
The ability to select and archive digital media from other sites (e.g., FACEBOOK®, YOUTUBE™, TWITTER™ and FLICKR™)

As shown and described, the system also has an easy to grasp concept with easy to use tools. The system will help change the paradigm—individuals will have the tools necessary to document their life story while it's happening instead of relying on friends and family members to do it on their behalf after they have passed away. Whether online or through the mobile app, the present system can help us to begin chronicling the celebration of one's life rather than mourning the inevitable.

A 2011 study indicated that the average FACEBOOK® user spends eight hours a month on FACEBOOK®. However, most people spend little to no time planning for death. The reason is simple that no one wants to talk about the one inevitable fact of life, i.e., everyone dies. And those that do find themselves in a terminal situation often scramble to document as much as they can but often do not have the tools necessary to easily document important messages they wish to pass on. The concept is not difficult to grasp as evidenced by the fact that the book, “The Last Lecture,” has sold over 14 million copies since 1997. If only everyone was an author we might spend the time documenting what we have learned about ourselves while living on this earth.

In light of “Baby Boomer” aging statistics, the disclosed system could be targeted specifically toward adults age 35 or older. However, the concept would likely be appealing to those battling terminal situations, including children, while still healthy enough to document their thoughts.

The shifting baby boomer demographics are widely known but worth noting. By 2015, almost 15% of the U.S. population will be age 65 or older. By 2020, 16.5% will be over age 65, and by 2035 we will peak at almost 21% or roughly 1 in 5 people living in the U.S. at that time (see http:/.babyboomer-magazine.com/news/165/ARTICLE/1514/2012-02-17.html).

Combine baby boomer aging statistics with the fact that technology continues to become less intimidating. A recent study suggest that 13% of social media website users are over the age of 55. Further, 19% are between the ages of 45-54 and another 25% are between the ages of 35 and 44 (see http://royal.pingdom.com/2010/02/16/study-ages-of-social-network-users/).

These statistics would suggest that as the population ages there will be an increased number of senior citizens that have grown accustomed to using sites like FACEBOOK®, TWITTER™ and LINKEDIN™.

As to mobility, the present system can be configured to operate as a smart phone app, called, for example, iLIB. Smart phones are one of the reasons why technology has become less intimidating to older generations. In 2015, projections show there will be over 176 million smart phone users in the U.S. alone (see http://www.statista.com/statistics/20182/forecast-of-smartphone-users-in-the-us/).

The disclosed system provides unique and useful social media integration. Another key differentiator for the present system is that members can copy and paste LIB Keepsakes directly from their FACEBOOK® account into their secure LIB Library. For example, a FACEBOOK® user uploads a picture to their FACEBOOK® account but later determines that they want to assign that LIB Keepsake to one of their beneficiaries. The user will simply select the document while in FACEBOOK®, right click and elect to upload it to the system. From there they will follow the exact same process as uploading an original document. Future iterations of present system and web-based program can provide users with the same ability for other social media websites including, but not limited to, TWITTER™, YOUTUBE™, and FLICKR™. The program may complement other social media websites by providing a secure location for users and providing a purposeful extension to how they use social media websites today.

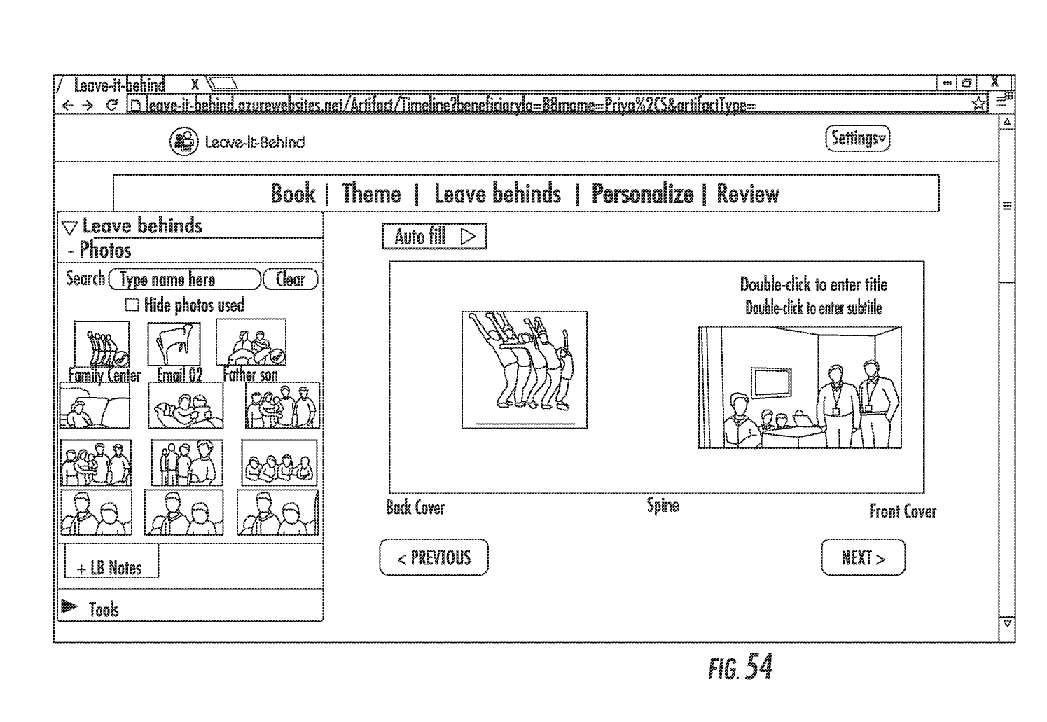

A printable storybook feature may also be a feature of an embodiment of the present system. With reference to FIGS. 47-58, an embodiment of the printable storybook feature is shown and described in some detail.

The printable storybook feature may provide a powerful and flexible canvas for the user to tell his or her story. Use of a WYSIWYG editor, as are well-known in the art, allows images and text to be overlaid to one another. Further, the editor may use both a low resolution window, for editing and personalization, and a high resolution window, for finalizing before printing.

As shown in the figures, selection of a storybook size and cover may be the first step. A theme for the storybook may then be selected, such as family memories, vacation, etc. To populate the storybook, the user may then be allowed to select any number of keepsakes. After selection, the user can either arrange the keepsakes as they want or allow the software to automatically fill the storybook. The book can then be personalized by adding information, such as names, dates, event title, and the like, and/or additional artwork, such as template frames, clip art, designs, and the like. Finally, the storybook can be assigned to a specific beneficiary and a time or event may selected for delivery of the storybook. Payment options would also be provided. Importantly, until the occurrence of the designated delivery date or event, the user may make additional changes to the storybook, including adding further keepsakes.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

1. A network-based system for recording digital assets of a first entity and delivering at least some of the digital assets to at least a second entity at a designated time or event, the system comprising:
a designated server coupled to a network and having memory for storing digital assets;
an electronic device configured to access the server via the network and capable of storing digital assets;
a first administrative tool for acquiring digital assets belonging to the first entity and storing the digital assets on the electronic device;
a second administrative tool for uploading the digital assets from the electronic device to the designated server;
a third administrative tool for assigning at least some of the digital assets uploaded to the server to at least one second entity upon one of either a specified time or a specified event; and
a fourth administrative tool for delivering the assigned digital assets to the at least one second entity on the occurrence of the specified time or specified event.

2. The network-based system of claim 1, wherein at least one of the first, second, third and fourth administrative tools reside on the electronic device.

3. The network-based system of claim 1, wherein each of the first, second, third and fourth administrative tools resides on the electronic device.

4. The network-based system of claim 1, further comprising a fifth administrative tool for organizing the digital assets.

5. The network-based system of claim 4, wherein the digital assets are at least one type selected from the group consisting of photos, videos, documents, audio files, cards, and messages.

6. The network-based system of claim 5, wherein the fifth administrative tool organizes the digital assets by type.

7. The network-based system of claim 5, wherein the fifth administrative tool organizes the digital assets chronologically.

8. The network-based system of claim 1, further comprising a sixth administrative tool for uploading and holding digital assets to the server from the electronic device without assigning the assets to a second entity.

9. The network-based system of claim 1, wherein the electronic device is one of either a personal computer, a smart phone or a tablet.

10. The network-based system of claim 1, wherein the digital assets are transferred from a network-based website.

11. The network-based system of claim 4, wherein the digital assets are organized to be displayed in a storybook.

12. The network-based system of claim 1, wherein there are a plurality of second entities and each of the plurality of second entities is assigned at least one digital asset.

13. A method for recording digital assets of a first entity and delivering at least some of the digital assets to at least a second entity at a designated time or event, the method comprising the steps of:
acquiring at least one digital asset and loading the asset onto an electronic device;
uploading the at least one digital asset from the electronic device onto a server for storage;
accessing the server via an electronic device;
assigning the at least one digital asset uploaded to the server to an entity;
designating one of either a time or an event for electronic delivery of each assigned asset; and
upon occurrence of either the designated time or event, electronically delivering each assigned asset to the assigned entity.

14. The method of claim 13, wherein the at least one digital asset is at least one type selected from the group consisting of photos, videos, documents, audio files, cards, and messages.

15. The method of claim 14, further comprising the step of organizing the digital assets by type.

16. The method of claim 13, further comprising the step of creating a storybook from the digital assets.

17. The method of claim 13, wherein the step of delivering the assigned asset is recurring based on one of either a recurring event or recurring time.

18. The method of claim 13, wherein the step of delivering occurs upon notice of the death of the first entity.

19. The method of claim 13, further comprising the step of transferring digital assets from a website.

20. A method for recording digital assets of a first entity and delivering at least some of the digital assets to at least a second entity at a designated time or event, the method comprising the steps of:
acquiring a plurality of digital assets onto an electronic device, the plurality of digital assets being at least one type selected from the group consisting of photos, videos, documents, audio files, cards, and messages;
uploading the plurality of digital assets from the electronic device onto a server for storage;
accessing the server via an electronic device;
assigning the at least one of the plurality of digital assets uploaded to the server to at least one second entity;
designating one of either a time or an event for electronic delivery of each assigned asset; and
upon each occurrence of either the designated time or event, electronically delivering each assigned asset to the assigned second entity.
